(19) United States
(12) Patent Application Publication
(10) Pub. No.: US 2005/0232837 A1
(43) Pub. Date: Oct. 20, 2005

(54) Compositions and methods for generating hydrogen from water

(76) Inventors: Tomasz Troczynski, Vancouver (CA); Edith Czech, North Vancouver (CA)

Correspondence Address: MCDERMOTT WILL & EMERY LLP, 18191 VON KARMAN AVE., SUITE 400, IRVINE, CA, 92612-7107, US

(21) Appl. No.: 11/103,994

(22) Filed: Apr. 11, 2005

Related U.S. Application Data
(60) Provisional application No. 60/560,597, filed on Apr. 9, 2004.

(51) Int. Cl. C01B 3/08; C22B 26/20

(52) U.S. Cl. 423/155; 502/251; 423/657

(57) ABSTRACT

The present invention relates to methods, compositions and systems for producing hydrogen from water involving reacting metal particles with water in the presence of an effective amount of catalyst. In particular the invention pertains to methods, compositions and systems for producing hydrogen upon reaction of metal particles selected from the group consisting of aluminum (Al), magnesium (Mg), silicon (Si) and zinc (Zn) with water, in the presence of an effective amount of a catalyst, wherein the catalyst is a water-soluble inorganic salt.

### FIELD OF THE INVENTION

The present invention relates to methods, compositions and systems for generating hydrogen from water. More particularly, this invention pertains to metal-catalyst compositions, systems and methods of producing hydrogen from water using metal-catalyst compositions, where the catalyst comprises a water soluble inorganic salt.

### BACKGROUND

The generation of hydrogen utilizing inexpensive simple processes is becoming increasingly important. The increasing demand for hydrogen arises from the imminent paradigm shift to a hydrogen-based energy economy, such as in hydrogen fuel cells. This shift approaches as the worldwide need for more electricity increases, greenhouse gas emission controls tighten, and fossil fuel reserves wane. The attendant market for fuel generators addresses the near term lack of hydrogen supply infrastructure that is necessary for the proliferation of the hydrogen fuel cell. Hydrogen-based economy is the only long-term, environmentally benign alternative for sustainable growth. Over the last few years it is becoming more apparent that the emphasis on cleaner fuel will lead to use of hydrogen in a significant way. Providing that renewable energy sources, such as hydroelectricity or solar energy, are used to produce hydrogen through decomposition of water, there are no environmental threats produced by the hydrogen economy.

The common method to recover hydrogen from water is to pass electric current through water and thus to reverse the oxygen-hydrogen reaction, i.e. in water electrolysis. This method requires access to continued supply of electricity, i.e. typically access to a power grit. Another method involves extraction of hydrogen from fossil fuels, for example from natural gas or methanol. This method is complex and always results in residues, such as carbon dioxide, at best. And there is only so much fossil fuel available. In these reforming methods the resulting hydrogen must be somehow stored and delivered to the user, unless the hydrogen generation is performed “on-board”, close to the consumption system. Safe, reliable, low-cost hydrogen storage and delivery is currently one of the bottlenecks of the hydrogen-based economy.

In the art, controlled generation of hydrogen has been described. For example, several U.S. patents, describe controlled hydrogen generators that employ alkali metals (U.S. Pat. Nos. 4,356,163; 5,514,353; 3,716,416) or metal hydrides (U.S. Pat. No. 5,593,640), or iron (U.S. Pat. No. 5,510,201) and water, as well as a generator that employ hydrochloric acid and pure metal (U.S. Pat. No. 4,988,486). More recently, the controlled generation of hydrogen from spherical polyethylene-coated Na or NaH pellets (U.S. Pat. Nos. 5,817,157 and 5,728,464) has been described. This system comprises a container to hold the pellets and water, a hydraulic system for splitting open the pellets, and a hydrogen sensor and computer which provides a feedback loop for activating the pellet splitter.

The generation of hydrogen gas in an uncontrolled manner is also known (U.S. Pat. Nos. 5,143,047; 5,494,538; 4,072,514; 4,064,226; 3,985,865; and 3,966,895) in systems comprising mixtures of alkali or alkali earth metals and/or aluminum and water or aqueous salt solutions. These reactions are based on the fact that some metals spontaneously react with water to produce hydrogen gas. These are, for example, alkaline metals such as potassium (K) or sodium (Na). These metals can be used as water-split agents through a simple reaction, which proceeds spontaneously once the metal is placed in contact with water:
2K+2H₂O→2KOH+H₂ (A)

Similar reactions can be written for other alkali metals, e.g. Na. Unfortunately hydroxide chemicals (i.e. the residual KOH in the above reaction (A)) cause very high alkalinity of the resulting products, making them corrosive, dangerous to handle, and potentially polluting to the environment. Because the reaction (A) proceeds spontaneously and violently, the reactive metals must be always protected from undesirable contact with water when being stored or otherwise not directly and usefully used to generate hydrogen gas (i.e. the metals must also be protected from air which under normal conditions will contain water vapor). This increases the cost of the technology and adds safety and pollution problems. A further disadvantage is that the reaction products are not easy to handle and recycle.

Reaction (A) has an advantage in that the reaction products (i.e. KOH) continuously dissolve in the reacting water, and thus allow the reaction to continue until all metal reacts. A similar effect has been difficult to achieve with other reactive metals, such as aluminum, because in this case after reaction with water the metal containing reaction products, i.e. Al(OH)₃ or AlOOH, in combination with aluminum oxide, tend to deposit on the surface of the reacting metal and thus restrict access of reactants (e.g. water) to metal surface, eventually stopping the reaction. This “passivation” phenomenon is a fortunate property of reactive metals such as Al, as it preserves them in a substantially corrosion-free state in a wide variety of applications, as long as their environment is not too acidic or alkaline. At the same time, passivation does not allow the use of Al for the generation of hydrogen from water at close to neutral pH.

A number of variants of the water split reaction used to produce hydrogen have been described in the past to overcome these problems. In particular, U.S. Pat. Nos. 6,440,385 and 6,582,676 describe a process wherein Al continuously reacts with water to produce hydrogen (and aluminum hydroxide Al(OH)₃), in neutral or near-neutral pH range (pH=4-10). The reaction occurs in the presence of an effective amount of catalyst; wherein the metal (typically Al) and catalyst are blended into intimate physical contact; and wherein the catalyst is in the form of catalyst particles in the size range 0.1-1000 μm.

A number of types of catalysts are suggested in the art, namely non-soluble ceramic particles such as alumina or other aluminum ion containing ceramics (such as aluminum hydroxide), other ceramics such as MgO or SiO₂, but also calcium carbonate or hydroxide, carbon, and organic water soluble compounds such as polyethylene glycol. Blending of the metal (such as Al) and the catalyst is made by pulverizing the metal and the catalyst to expose fresh surfaces of the metal. In addition to pulverization, the metal and the catalyst can be pressed together to form pellets after which, the pellets can be mixed with water.

European Patent No. 0 417 279 B1 teaches the production of hydrogen from a water split reaction using aluminum and a ceramic namely calcined dolomite, i.e. calcium/magnesium oxide. Once contacted with water, these oxides cause very substantial increase of pH (i.e. create an alkaline environment), which stimulates corrosion of Al with accompanying release of hydrogen. The system has all the disadvantages of water split reactions using alkaline metals, i.e. high alkalinity and difficult recyclability of the products. In one case, the Mg and Al are mechanically ground together to form a composite material which is then exposed to water (U.S. Pat. No. 4,072,514).

Continuous removal of the passivation layer on aluminum by mechanical means, in order to sustain aluminum assisted water split reaction, has also been described in the art (FR Pat. No. 2,465,683). This patent describes a method of automatic gas production by reaction of alkaline solution with metal-incorporating feeding without interruption of reaction and continuous metal cleaning applicable in producing hydrogen for energy source. For hydrogen production, aluminum on sodium hydroxide solution in water was used.

Aluminum metal-water systems including water-soluble inorganic salt (WIS) solutions have also been described. For example, the chemistry of aluminum exposed to water-soluble inorganic salt solutions, in namely, halide solutions, is well represented in the literature. E. McCafferty in “Sequence of steps in the pitting of aluminum by chloride ions” (Corrosion Science 45 (2003) 1421-1438) described that the pitting of aluminum involves a sequence of steps. The steps involved in the pit initiation process are considered to be adsorption of chloride ions at the oxide surface, penetration of the oxide film by chloride ions, and Cl⁻-assisted dissolution which occurs beneath the oxide film at the metal/oxide interface. It is proposed that chloride ions penetrate the oxide film by a film dissolution mechanism in addition to Cl-penetration through oxygen vacancies. Corrosion pit propagation leads to formation of blisters beneath the oxide film due to localized reactions which produce an acidic localized environment. The blisters subsequently rupture due to the formation of hydrogen gas in the occluded corrosion cell. Calculation by McCafferty et al of the local pH within a blister from the calculated hydrogen pressure within the blister gives pH values in the range 0.85 to 2.3.

A. G. Munoz and J. B. Bessone, in “Pitting of aluminum in non-aqueous chloride media” (Corrosion Science 41 (1999) 1447-1463), propose several theories in order to explain pitting mechanism and the influence of factors such as the type of anion present, the pH, and the characteristics of surface passive layer. In general, the adsorption of aggressive anions on surface oxide flaws and their penetration and agglomeration at these imperfection sites was considered as a possible explanation for pit nucleation. It was also suggested that pits can develop by means of a hydrolysis process that gives rise to a localised acidification that avoid further repassivation. Thus, the role played by chloride ions in the initiation of pitting is not totally clear.

A. Berzins, R. T. Lowson, K. J. Mirams, in “Aluminum Corrosion Studies. III. Chloride Adsorption Isotherms on Corroding Aluminium” (Aust. J. Chem., 1977, 30, p. 1891-1903) studied the amount of chloride adsorbed, w_{Cl}, as a function of chloride concentration [Cl], and time. It was found that addition of nitrate or sulphate to the chloride solution delayed the uptake of chloride. Al specimens immersed in 1 mol/l Cl⁻ solutions reached the grey stage (from mirror polished finish) after one day and by 70 days had a very thick coating of white powder. Sodium sulphate and NaNO₃ addition slowed down the development of the corrosion deposits.

Aballe, M. Bethencourt, F. J. Botana, M. J. Cano and M. Marcos, in “Localized alkaline corrosion of alloy AA5083 in neutral 3.5% NaCl solution” (Corrosion Science Volume 43, Issue 9, September 2001, Pages 1657-1674) studied corrosion process of the alloy AA5083 in an aerated solution of NaCl at 3.5%. The results obtained indicate that this alloy shows localized corrosion due to alkalinization around the cathodic precipitates existing in the alloy. The pitting formed presents a hemispherical morphology that is clearly different from crystallographic pitting. The formation of crystallographic pitting has not been observed, even in samples submitted to tests of very long duration. In order to obtain the formation of crystallographic pitting, it is necessary to polarize the alloy at the nucleation potential of pitting and, in addition, the density of the current must be above a critical value. Only when the layer of oxide is eliminated does the formation of crystallographic pitting take place by simple exposure in an aerated solution of NaCl at 3.5%.

The general conclusion from the literature sources is that corrosion by pitting in aluminum alloys in an aggressive medium, such as aerated solution of NaCl at 3.5% and at pH 5.5, is a complex process. It can be affected by diverse experimental factors such as the pH, the temperature, the type of anion present in the solution, and the physico-chemical characteristics of the passive layer. The adsorption of aggressive ions such as Cl⁻ into the faults in the protective film, and their penetration and accumulation in these imperfections, is considered one of the triggering factors of the process of nucleation of pitting. Pits may develop as a result of a process of hydrolysis which gives rise to a local reduction of the pH which, in turn, impedes the subsequent process of re-passivation. Another factor which is associated with the susceptibility of aluminum to pitting corrosion and other forms of localized corrosion is the electrochemical nature of the intermetallic phases. Generally, pitting corrosion occurs when the aqueous environment contains aggressive anions, such as chlorides, sulphates or nitrates, especially of alkaline metals such as sodium or potassium.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide compositions and methods for generating hydrogen from water. In accordance with an aspect of the present invention, there is provided composition for producing hydrogen upon reaction of said composition with water, said composition comprising: metal particles selected from the group consisting of aluminum (Al), magnesium (Mg), silicon (Si) and zinc (Zn); and an effective amount of a catalyst.

In accordance with another aspect of the invention, there is provided a method for preparing a metal-catalyst composition, comprising the steps of: providing metal particles that are sufficiently electropositive that the bare surface of said particles will react with water to effect a water split reaction; selecting a catalyst suitable to catalyze the water split reaction; and blending the particles and the catalyst into intimate physical contact with one another.

In accordance with another aspect of the invention, there is provided a method for producing Hydrogen comprising reacting metal particles selected from the group consisting of aluminum (Al), magnesium (Mg), silicon (Si) and zinc (Zn) with water in the presence of an effective amount of catalyst at a pH of between 4 and 10 to produce reaction products which include Hydrogen, the catalyst comprising at least one water-soluble inorganic salt to facilitate the reacting of said metal particles with the water.

### BRIEF DESCRIPTION OF THE FIGURES

Further features objects and advantages will be evident from the following detailed description of the present invention taken in conjunction with the accompanying drawings which illustrate specific embodiments of the invention and are not intended to limit the scope of the invention in any way.

FIG. 1 shows a plot illustrating a comparison of hydrogen generation from standard (Al—Al₂O₃) and Al—NaCl powder mixtures according to embodiments of the invention;

FIG. 2 shows a plot illustrating a comparison of hydrogen generation from standard (Al—Al₂O₃) and Al—KCl powder mixtures according to embodiments of the invention;

FIG. 3 shows a plot illustrating a comparison of hydrogen generation from standard (Al—Al₂O₃) and Al—KCl powder mixtures (Spex-milled and hand-mixed powders) according to embodiments of the invention;

FIG. 4 shows a plot illustrating a comparison of hydrogen generation from standard and Al-salt powder mixtures according to embodiments of the invention;

FIG. 5a shows an X-ray diffraction scan of all products after reaction completion in an Al—KCl (NaNO₃) system;

FIG. 5b shows an X-ray diffraction scan of all products after reaction completion in an Al—KCl (NaNO₃) system;

FIG. 6 shows an X-ray diffraction scan of insoluble reaction products after reaction completion in an Al—KCl system;

FIG. 7 shows an X-ray diffraction scan of insoluble reaction products after reaction completion in an Al—Al₂O₃ “standard” system;

FIG. 8 shows a plot illustrating a comparison of the effect of different salts (WIS) on the total amount of hydrogen produced from 1 g Al powder in one hour of Al corrosion reaction according to embodiments of the invention;

FIG. 9 show a plot illustrating the comparison of the Al—KCl and Al—NaCl systems and their total amounts of hydrogen produced from 1 g Al powder in two hours of Al corrosion reaction according to embodiments of the invention;

FIG. 10 shows a plot illustrating the effect of additives (NaNO₃) on the reaction kinetics of Al—KCl systems according to embodiments of the invention;

FIG. 11 shows a plot illustrating the effect of additives (Mg) on the reaction kinetics of Al—KCl systems according to embodiments of the invention;

FIG. 12 shows a plot illustrating the effect of water type on the reaction kinetics of Al—KCl systems according to embodiments of the invention;

FIG. 13 shows a plot illustrating a comparison of the effect of KCl concentration on the total amount of hydrogen generated from 2 g Al-WIS powder mixture in 2 hrs of corrosion reaction according to embodiments of the invention;

FIG. 14 shows a plot illustrating the effect of KCl concentration in the Al-WIS powder mixture on the total amount of hydrogen generated in 1 hr of corrosion reaction according to embodiments of the invention;

FIG. 15 shows a plot illustrating the effect of tap water temperature on the total amount of hydrogen produced from 1 g Al powder in 15 minutes and one hour of Al corrosion reaction according to one embodiment of the invention;

FIG. 16 shows a plot illustrating a comparison of the effect of water temperature on the total amount of hydrogen produced from 1 g Al powder in two hours of Al corrosion reaction according to embodiments of the invention;

FIG. 17a shows a plot illustrating pH and Temperature change during corrosion reaction of Al—KCl System according to one embodiment of the invention;

FIG. 17b shows a plot illustrating pH and Temperature change during corrosion reaction of Al—KCl(<1 wt % NaNO₃) System according to one embodiment of the invention;

FIG. 17c shows a plot illustrating pH and Temperature change during corrosion reaction of Al—Al₂O₃ System as a reference according to one embodiment of the invention;

FIG. 18 shows a plot illustrating the effect of various grinding times on the total amount of hydrogen produced from 1 g Al powder in 15 minutes and one hour of Al corrosion reaction according to one embodiment of the invention;

FIG. 19 shows a plot illustrating hydrogen generation from 15 min and 4 hrs ballmilled Al-WIS powders before and after regrinding—a comparison according to one embodiment of the invention;

FIG. 20 shows a comparison of X-ray diffraction patterns of Al-WIS powders as a function of ballmilling time;

FIG. 21 shows a comparison of X-ray diffraction patterns of Al—KCl powders with and without NaNO₃ additive after corrosion reaction. Reaction temperature: T=55° C.;

FIG. 22 shows a comparison of X-ray diffraction patterns of Al—KCl powders with and without NaNO₃ additive after corrosion reaction. Reaction temperature: 60° C.<T<95° C.; and

FIG. 23 shows a comparison of X-ray diffraction patterns of Al—KCl powders with and without NaNO₃ additive after corrosion reaction. Reaction temperature: T=100° C.

### DETAILED DESCRIPTION OF THE INVENTION

The present invention provides for compositions and systems for use in the production of hydrogen gas through the water split reaction, wherein the compositions and systems comprise a metal and a catalyst. The invention further provides for methods of preparing the metal-catalyst compositions of the invention and methods for producing hydrogen gas comprising reacting metal particles with water in the presence of an effective amount of catalyst. The compositions and methods of the present invention prevent formation of the passivation layer of products on a metal surface, thereby allowing the use of metals, or other similarly passivated metals, for the generation of hydrogen from water at close to neutral pH. As would be understood by a worker skilled in the art, the compositions, systems and method of producing hydrogen are contemplated for use in conjunction with any device requiring a hydrogen source.

Definitions

Unless defined otherwise, all technical and scientific terms used herein have the same meaning as commonly understood by one of ordinary skill in the art to which this invention belongs.

The term “additive” as used herein, refers to salts, including water soluble inorganic salts, or inorganic materials that may be added to the catalyst or combined with the catalyst to enhance the water split reaction.

The term “catalyst,” as used herein, refers to a substance or mixture of substances that can increase or decrease the rate of a chemical reaction without being consumed in the reaction.

The term “metal,” as used herein, refers to any non-Group 1 metal that is sufficiently electropositive that its bare surface will react with water, thereby generating hydrogen.

The term “milling,” as used herein, refers to various types of milling including, but not limited to, Spex milling, vibratory-milling, ball-milling, and attrition milling.

The term “pre-milling,” as used herein, refers to the milling of a catalyst, or catalyst and additive, in advance of milling of the metal and catalyst.

The term “WIS” as used herein, refers to a water soluble inorganic salt suitable for catalyzing the reaction as defined herein.

1. Compositions for Generating Hydrogen from Water

The present invention provides compositions for generating hydrogen from water. The metal-catalyst compositions of the present invention facilitate the production of hydrogen from water, upon the reaction of the compositions with water. In particular, the present invention provides for compositions comprising a mixture of a metal and a catalyst, which when contacted with water, produce hydrogen gas at a neutral pH of between 4 and 10.

Types of Metals

In accordance with the present invention, the metal included in the composition may be selected from any non-Group 1 metal that is sufficiently electropositive that its bare surface will react with water to effect the water split reaction, thereby generating hydrogen. Non-limiting examples of suitable metals include aluminum (Al), magnesium (Mg), silicon (Si) and zinc (Zn). Accordingly, in one embodiment of the present invention, the metal of the composition is selected from the group comprising aluminum (Al), magnesium (Mg), silicon (Si) and zinc (Zn). In another embodiment of the present invention, the metal of the composition is aluminum (Al). In addition, metal combinations have been contemplated. Thus, in another embodiment of the invention there is provided a composition comprising two or more metals selected from the group comprising aluminum (Al), magnesium (Mg), silicon (Si) and zinc (Zn). Various sources of these metals would be readily known to a worker skilled in the art. For example, forms including, but not limited to, granule or particulate are suitable for the preparation of the inventive compositions.

Types of Catalysts

For the purposes of the present invention, the catalyst of the composition may be selected from any water soluble inorganic salt (WIS). Non-limiting examples of suitable catalysts include, halides, sulphates, sulphides, and nitrates of the Group 1 or Group 2 metals. Various sources of these salts would be readily known to a worker skilled in the art. Salts in granule or particulate form are non-limiting examples of sources suitable for the preparation of the inventive compositions. The catalyst may be selected from the group comprising chlorides such as for example NaCl, KCl, CaCl₂, nitrates such as for example NaNO₃, or other salts such as sulphates or carbonates. Based on the extensive body of experimental evidence collected it appears that the chemical nature of the catalyst is secondary as far as the ability to initiate the metal-assisted water split reaction. The catalysts do not enter the reaction with the metal, i.e. no metal chlorides form, only the metal hydroxides (and hydrogen) form during the reaction. It is the homogenous mechanical blending of the catalyst salt with the metal, and the solubility of the catalyst in water or other suitable medium, which appears to impact the continued water split reaction the most. Therefore, suitably soluble salts of other metals and salts of non-metal cations are also contemplated as being within the scope of this invention. For example, NH₄Cl, are suitable as catalysts in the compositions of the present invention. Accordingly, in one embodiment of the invention, the catalyst of the composition is selected from the group consisting of NaCl, KCl, NH₄Cl, CaCl₂ and NaNO₃. Furthermore, WIS combinations have also been contemplated. Thus, in one embodiment of the present invention, the catalyst of the composition is a WIS. In another embodiment of the present invention, the catalyst of the composition comprises two or more WIS.

Additionally, it is clear from the examples, that WISs play the role of catalysts, and therefore remain as chemically unchanged water-soluble salts after completion of the mechanical blending with a metal, as well as after completion of the reaction (i.e. the only solid reaction product is metal hydroxide). This important characteristic of the metal-WIS compositions, in addition to water solubility of the catalyst, indicates that WIS will be easy to recover and recycle in the commercial systems for on-board H₂ generation.

Pre-Treatment of Catalyst

a) Pre-Milling

Also contemplated herein is the pre-milling of a catalyst prior to metal-catalyst blending. For the purpose of the present invention, the methods of pre-milling include, but are not limited to, Spex milling, vibratory-milling, ball-milling, and attrition milling. Both pre-milling and the duration of pre-milling affect particle size. Accordingly, in one embodiment of the invention, the pre-milling time is from about 5 min to about 30 min. In another embodiment of the invention, the pre-milling time is from about 5 min to about 15 min. In another embodiment of the invention, the pre-milling time is from about 15 min to about 30 min.

b) Additives

As illustrated in the figures, a catalyst may be combined with an additive. Depending on their amount and chemistry they can either favour or block the metal corrosion reaction. For example, small amounts of nitrates (such as NaNO₃) or metal (e.g magnesium) additives significantly enhance the effect of chlorides, such as KCl. The additive may be combined with the catalyst by any form of mixing. Non-limiting examples of mixing include hand-mixing, mixing, blending, milling (Spex milling, vibratory-milling, ball-milling, and attrition milling) and other methods. In one embodiment of the invention, the catalyst may be combined with one or more additives. In another embodiment of the invention, the catalyst may be combined with NaNO₃. In another embodiment of the invention, the catalyst may be combined with trace (<1%) amounts of NaNO₃. In another embodiment the catalyst may be combined with Mg.

Combination of Metal-WIS Compositions

For effective metal-assisted water split reactions, the metal-WIS catalyst compositions of the present invention may be mechanically alloyed or otherwise intimately blended. The metal and catalyst of the invention may be physically in intimate contact with one another, for example, as the metal is plastically deformed, and the catalyst is fractured to small particle size. For the purposes of the present invention, the metal and the catalyst may be present in the form of particles having a size between about 0.01 and 10000 μm. Thus, in accordance with one embodiment of the invention, the metal and the catalyst are in the form of particles having a size between 0.01 and 10000 μm. In accordance with another embodiment of the invention, the metal and the catalyst are in the form of particles having a size between 0.01 and 1000 μm. In accordance with another embodiment of the invention, the metal and the catalyst are in the form of particles having a size between 0.01 and 500 μm. In accordance with another embodiment of the invention, the metal and the catalyst are in the form of particles having a size between 0.01 and 250 μm. In accordance with another embodiment of the invention, the metal and the catalyst are in the form of particles having a size between 0.01 and 100 μm. This particle size can be achieved by mixing, as defined herein.

a) Blending

In blending by any hand or mechanical mixing it is expected that the particle size of the initial components in the mixture will have an influence on final state of the mixed powder. It is also expected that the type of equipment used for the blending will have a bearing on the final state of the mixed powder. Hand mixing or blending is laborious and hydrogen production is generally less than that obtained from using a mixed powder produced by milling or mechanical alloying. Accordingly, in one embodiment of the invention the metal and catalyst are milled.

i) Milling

As contemplated by the present invention, a plurality of milling methods including, but not limited to, Spex milling, vibratory-milling, ball-milling, and attrition milling (as well as other methods), may be employed to produce a mixed metal-catalyst composition. During the milling process, the metal may deform plastically, otherwise known as “mechanical alloying”.

As would be understood by a worker skilled in the art, the larger the open porosity of the metal milled with WIS, the larger is the surface area of the metal-catalyst mixture exposed to water, and thus the higher the rate of the reaction (i.e. larger amount of the metal reacts with water in unit time, e.g. 1 hr), and the higher the yield of the reaction (i.e. larger amount of the metal reacts with water). Additionally, plastic deformation of the compositions of the invention by a process such as mechanical alloying resulting from milling, for example in Spex vibratory mill or other forms of intensive milling such as attrition milling, is contemplated by the present invention.

b) Milling Time

As illustrated by the examples, the duration of milling may also effect hydrogen production. Accordingly, the length of milling and pre-milling may be predetermined. In one embodiment of the invention, the milling time is from about 7.5 min to about 4 hrs. In another embodiment of the invention, the milling time is from about 7.5 min to about 20 min. In another embodiment of the invention, the milling time is from about 20 min to about 30 min. In another embodiment of the invention, the milling time is from about 30 min to about 40 min. In another embodiment of the invention, the milling time is from about 50 min to about 60 min.

Given the foregoing, in one embodiment, there is provided a composition for producing hydrogen upon reaction of said composition with water, said composition comprising:
a) metal particles selected from the group consisting of aluminum (Al), magnesium (Mg), silicon (Si) and zinc (Zn); and
b) an effective amount of a catalyst, the catalyst comprising at least one water-soluble inorganic salt,
   wherein said metal particles and said catalyst are in intimate physical contact.

In another embodiment of the invention, deformation may be achieved by blending and mechanical alloying (e.g. using Spex vibratory milling, or other form of intensive milling such as attrition milling) the metal powder with a WIS-catalyst that:
(i) does not react with the metal, or otherwise chemically change during blending;
(ii) can be ground relatively easily during the blending process, and/or has small particle size, 0.1-100 μm, at the outset of the process, thereby allowing it to blend intimately throughout the deforming metal;
(iii) catalyses the water split reaction;
(iv) assures connectivity between the blended additive particles; and
(v) leaches out of the blended metal-additive composite, through exposure to the water during the reaction. The water-soluble additives (WIS) leach during the water split reaction and help to carry away the solid reaction products.
   Solubility

The solubility of the chemically active inorganic salts (WIS) additionally facilitates generation of hydrogen from water, or other convenient solvents (such as alcohols) by providing continuous opening of the fresh surface of the metal for reaction, and aiding in removal of the solid reaction product (i.e. metal hydroxide) from the reaction zone, unlike other known catalysts such as water-insoluble ceramic particles (e.g. alumina). Such non-soluble particles, in contrast, will block open porosity in the reacting metal, and therefore accelerate accumulation of the solid product of reaction (e.g. Al(OH₃)), leading to rapid decline of reaction kinetics. Accordingly, in one embodiment of the present invention, the catalyst salt has a solubility in excess of 5×10⁻³ mol/100 g water. In accordance with another embodiment of the invention, the salt catalyst has a solubility in excess of about 0.1 mol/100 g water. The solubility of the WIS is not limited to water but may include solubility in other convenient solvents such as alcohols. Solubility in water is preferred due to convenience, low cost and environmental factors.

Ratio

The ratio of metal-catalyst during the blending or milling operations may additionally affect the rate of the metal-assisted water split reaction. Accordingly, in one embodiment of the invention, the metal and the WIS catalyst are present in a ratio of between about 1000:1 and about 1:1000 by weight. As well it is known in the art that very small amounts of catalyst may have a very strong effect on catalysed reactions. In another embodiment of the invention, the metal and the WIS catalyst are present in a ratio of between about 100:1 and about 1:10 by weight. In another embodiment of the invention, the metal and the WIS catalyst are present in a ratio of between about 95:5 and about 10:90 by weight. In accordance with another embodiment of the invention, the metal and the WIS catalyst are present in an approximately 1:1 ratio by weight. In accordance with another embodiment of the invention, the metal and the WIS catalyst are present in an approximately 50:50 ratio by weight. In accordance with another embodiment of the invention, the metal and the WIS catalyst are present in an approximately 30:70 ratio by weight.

Methods for Preparing Metal-Catalyst Compositions

The present invention further provides for methods of preparing the metal-catalyst compositions of the invention. In accordance with the compositions of the instant invention, the catalyst may comprise a WIS in combination with one or more other WIS or the catalyst may comprise a WIS in combination with one or more additives.

The methods for preparing a metal-catalyst composition according to the present invention comprise the steps of:
a) providing non-Group 1 metal particles, as described herein, that are sufficiently electropositive that the bare surface of the particles will react with water to effect the water split reaction;
b) selecting a catalyst, as described herein, suitable to catalyze a water split reaction; and
c) blending the metal and catalyst into intimate physical contact with one another.

For the purposes of the present invention, the catalyst may optionally be pre-milled prior to step c, with the steps of milling and pre-milling to be performed as described above.

In one embodiment of the invention, the method of preparing a metal-catalyst composition comprises the steps of:
a) providing metal particles selected from the group consisting of aluminum (Al), magnesium (Mg), silicon (Si) and zinc (Zn);
b) selecting a catalyst from the group consisting of NaCl, KCl, CaCl₂ and NaNO₃; and
c) blending the metal and catalyst into intimate physical contact with one another.
   2. Methods for Generating Hydrogen from Water Split Reaction

It is a further object of this invention to provide methods of producing hydrogen from water using metal-catalyst compositions. In particular, there is provided methods of producing hydrogen gas comprising reacting metal particles with water in the presence of an effective amount of catalyst.

For the purpose of the present invention, the metals and catalysts employed for the hydrogen generating water split reaction are selected as outlined above. Similarly, the solubility, ratio and composition of the employed catalyst of the method are encompassed here, as previously defined with reference to the metal-catalyst compositions of the invention. Accordingly, there is contemplated a method of producing hydrogen comprising reacting metal particles selected from the group consisting of aluminum (Al), magnesium (Mg), silicon (Si) and zinc (Zn) with water in the presence of an effective amount of catalyst at a pH of between 4 and 10 to produce reaction products which include hydrogen with the catalyst comprising at least one water-soluble inorganic salt.

Where the compositions of the present invention are blended, they are to be understood as previously described herein. As such, according to the methods of the present invention, the mechanical alloying of metal in the presence of WIS, followed by continuous exposure of the resultant deformed metal-WIS compositions to water, allows for a sustained water split reaction.

As illustrated by the examples, the chemical reactions of the instant invention are additionally affected by temperature and pH. Accordingly, as would be understood by a worker skilled in the art, the temperature or pH of the metal-catalyst reaction may be increased or decreased in such a way so as to produce hydrogen at a predetermined or desired rate. Typically, the metal-catalyst promoted water split reaction occurs at a pH of between 4 and 10. Thus, in one embodiment of the invention, there is provided a method of producing hydrogen from a metal-catalyst reaction wherein the pH is between 4 and 10. In another embodiment there is provided a method for producing hydrogen from a metal-catalyst reaction wherein the pH is between about 4 and 9. In another embodiment there is provided a method for producing hydrogen from a metal-catalyst reaction wherein the pH is between about 4 and 5. In another embodiment there is provided a method for producing hydrogen from a metal-catalyst reaction wherein the pH is between about 5 and 6. In another embodiment there is provided a method for producing hydrogen from a metal-catalyst reaction wherein the pH is between about 6 and 7. In another embodiment there is provided a method for producing hydrogen from a metal-catalyst reaction wherein the pH is between about 7 and 8. In another embodiment there is provided a method for producing hydrogen from a metal-catalyst reaction wherein the pH is between about 8 and 9. In another embodiment there is provided a method for producing hydrogen from a metal-catalyst reaction wherein the pH is between about 9 and 10. In another embodiment there is provided a method for producing hydrogen from a metal-catalyst reaction wherein the pH is 6.5. With respect to temperature, there is provided a method of producing hydrogen from a metal-catalyst reaction wherein the temperature of the water is between 22 and 100° C., according to one embodiment of the invention. In accordance with another embodiment, there is provided a method of producing hydrogen from a metal-catalyst reaction wherein the temperature of the water is between 22 and 40° C. In accordance with another embodiment, there is provided a method of producing hydrogen from a metal-catalyst reaction wherein the temperature of the water is between 40 and 55° C. In accordance with another embodiment, there is provided a method of producing hydrogen from a metal-catalyst reaction wherein the temperature of the water is between 55 and 100° C. In accordance with another embodiment, there is provided a method wherein the temperature of the water is 55° C.

As further illustrated by the examples, water type may additionally effect metal-catalyst systems. Depending on the nature of the water, certain impurities are commonly found. Accordingly, various types of water have been contemplated for use in the inventive method. In addition, certain chemicals may be added to any type of water in order to increase the impurity of the liquid. Non-limiting examples of water types include, fresh, tap, distilled, marine and water adjusted to comprise a high chloride concentration. In one embodiment of the invention, the water of the method is selected from the group comprising fresh, tap, distilled, marine and water adjusted to comprise a high chloride concentration (e.g. KCl-saturated aqueous solution [Tₛₐₜᵤᵣₐₜᵢₒₙ=55° C.]). In another embodiment of the invention, the water of the method is tap water.

Given the above, one embodiment of the present invention provides for a method which leads to high-yield high-rate metal-assisted water split reaction comprising the following steps:
1. Providing a metal-catalyst composition; and
2. Exposing the metal-catalyst composition produced in step (1) to water, either liquid or vapour.
   In the second step, the exposure of the metal-WIS composite produced in step (1) to water, either liquid or vapour, assures the maximum porosity/surface area at the outset and during the reaction. In contrast to the art (U.S. Pat. Nos. 6,440,385 and 6,582,676), although contemplated, pelletization is less desirable. For the purposes of the present invention, loose powders contained in a container permeable to water and gas (the “tea-bag” arrangement) are contemplated.
   3. Metal-WIS Catalyst Systems

The present invention further provides for metal-catalyst systems. As would be understood by a worker skilled in the art, the systems and method of producing hydrogen may be used in conjunction with any device requiring a hydrogen source. Accordingly, the systems described in the present invention may accelerate introduction of hydrogen-derived power to consumer electronics (e.g. laptop computers), medical devices or transportation. In particular, use of such hydrogen source to power implantable medical device requires that chemistry of such device has minimal impact on the organism in case of failure of such device. The use of neutral or near-neutral water, and metal-WIS in such device conforms to this requirement.

For the purpose of the present invention, the metal-catalyst systems employed for the hydrogen generating water split reaction comprise:
a) a metal-catalyst composition according to the present invention;
b) water; and
c) means for containing the system.

It is understood that the metals and catalysts employed for the composition of the system are as outlined above, as is the solubility, ratio and composition of the catalyst of the system. Similarly, the composition of the system are typically plastically deformed or mechanically alloyed, with respect to the metal-catalyst physical contact.

With reference to the examples, the rate of the water split reaction facilitated by mechanically alloyed metal-WIS systems of the present invention, is 2-3× faster as compared to similarly processed systems such as Al-alumina/ceramic (see U.S. Pat. Nos. 6,440,385 and 6,582,676), and at least 4-5× faster as compared to the similarly processed systems including water-soluble organic additives such as polyethylene glycol (also disclosed in U.S. Pat. Nos. 6,440,385 and 6,582,676). Accordingly, in one embodiment of the invention, there is provided a metal-catalyst system that is 2-5× faster than other hydrogen generating systems known in the art. Furthermore, the total reaction yield after 1 hr was 1.5-2× higher as compared to the similarly processed systems including ceramic additives such as alumina. Accordingly, the efficiency of the water split reaction of the metal-WIS system of the present invention is significant, given the reaction was nearly completed (i.e. with >95% H₂ yield) within ˜2 hrs (at 55° C. water temperature). In contrast, the Al-ceramic or Al with water soluble organics systems of the art reacted slowly even after ˜200 hrs, with the best overall reaction yield being less than ˜53% after ˜2 hrs. Thus, in accordance with another embodiment of the invention there is provided a metal-catalyst system that yields 1.5-2× more hydrogen than other hydrogen generating systems known in the art.

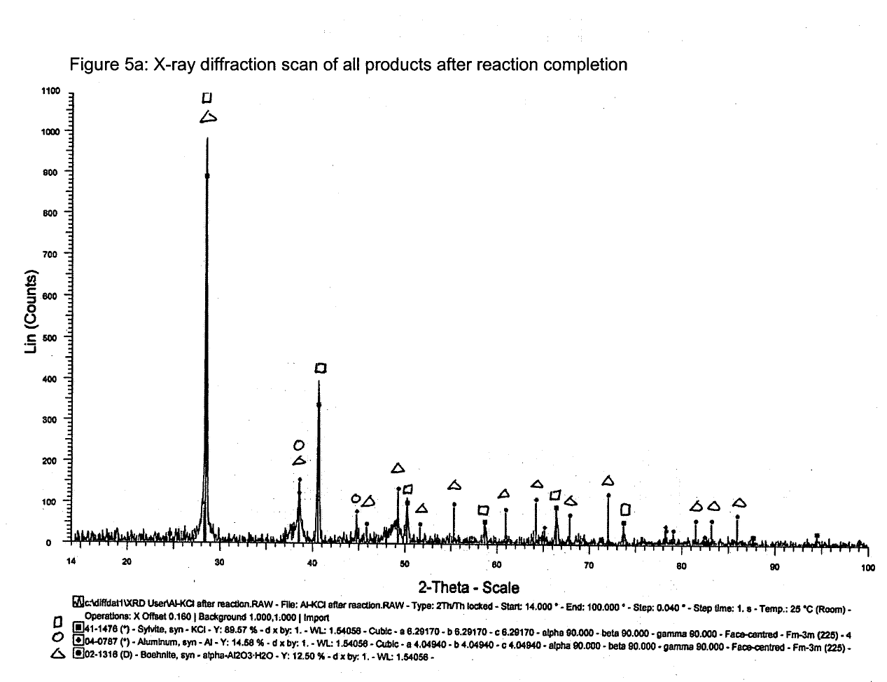

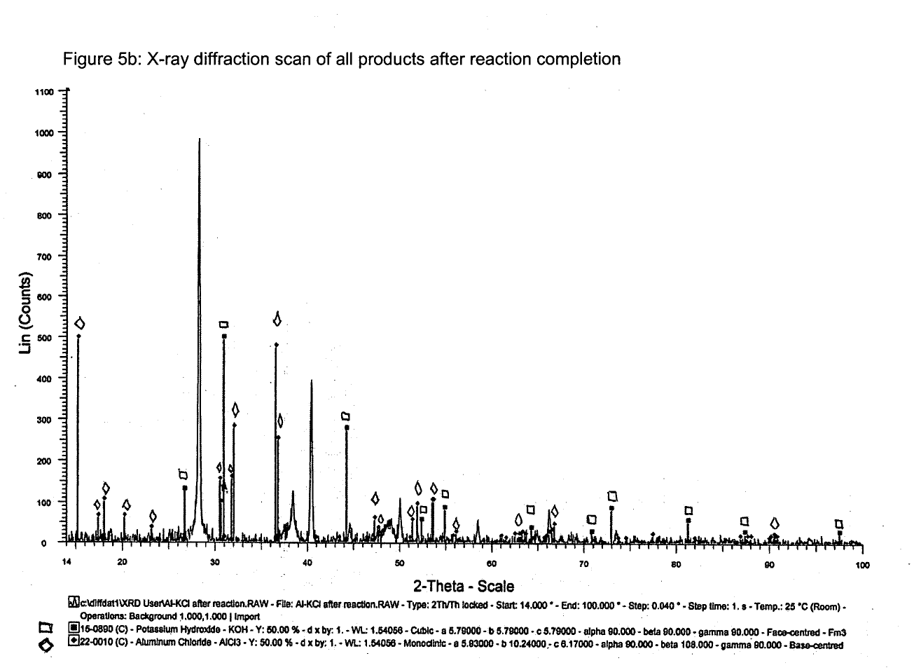

In contrast to the process disclosed in U.S. Pat. Nos. 6,440,385 and 6,582,676, wherein the stated products of the water split reaction, in presence of alumina or other ceramic or organic additives, were H₂ and Al(OH)₃, the Al-WIS systems of the present invention (see FIGS. 5a, and 5b) yielded H₂ and either pure aluminum monohydrate AlOOH or mixture of Al hydrates (as confirmed through X-ray diffraction scan [XRD]), according to the following reactions:

Al-Ceramic-Water Systems (U.S. Pat. Nos. 6,440,385 and 6,582,676):
Al+3H₂O→Al(OH)₃+1.5H₂ (B)
Al-WIS-Water Systems:
Al+2H₂O→AlOOH+1.5H₂ (C)

Thus, in the presence of equal amounts of Al content, the Al-WIS composition of the present invention, reaction (C), yielded the same amount of H₂ as reaction (A) while it used 33% less water. Furthermore, the solid reaction product of reaction (C), AlOOH, was 23% lighter as compared to the solid reaction product of reaction (B). As such, the weight and rate advantages according to the systems of the present invention are significant. Accordingly, in one embodiment of the invention, there is provided a metal-catalyst system that employs less water and has lighter solid reaction products than other hydrogen generating systems known in the art.

Furthermore, application of the water split reaction (C) to supply fuel cells with hydrogen would result at the exhaust in 1.5 molecules of water through reaction (D):
1.5H₂+0.75O₂→1.5H₂O (D)

These are very significant weight advantages considering the application of these systems to hydrogen generation for mobile devices. For example, reaction (C) requires only 2 molecules of water, thus a system further comprising water re-circulation means would require an input of only half-molecule of water per each atom of aluminum. Accordingly, the reaction systems contemplated by the present invention include, but are not limited to the above Al-WIS-FC system (C,D) wherein water recirculation would require only 9 g of water for each 27 g of aluminum. Similar system (B) with water recirculation (D) would require 27 g of water for each 27 g of aluminum, i.e. 300% more as compared to system (C). Thus, in one embodiment of the invention, there is provided a metal-catalyst system, further comprising a re-circulation system, whereby the system requires an input of only half-molecule of water per each atom of aluminum as compared to other hydrogen generating systems known in the art. On-board H2 generation systems for marine applications, e.g. powering of boats, may use the marine water after minimal filtration. Similarly, a medical implantable device may use a semi-permeable membrane to provide sufficient amount of water to continue the hydrogen generation reaction. Fortunately, water is omni-present on Earth. Ultimately therefore, the water required for the water-split reaction according to the present invention, may be obtained through condensation of water from the surrounding atmosphere or environment, thus minimising the need for on-board carrying of water for the reaction.

The advantage of the present invention over the prior art (U.S. Pat. Nos. 6,440,385 and 6,582,676) is clearly demonstrated by the significant weight requirements of the systems. As well, it is noteworthy to consider that metal hydroxide can be easily recovered from the solid reaction product by leaching the water soluble WIS catalyst, such as KCl. Hence, WIS catalysts may form an integral, recoverable part of the H₂ reactor, wherein only Al+H₂O need be supplied as an input. This is in contrast to reaction (B) wherein Al(OH)₃ cannot be easily separated from the non-soluble ceramic additive (reaction catalyst) such as aluminum oxide. Accordingly, given the reaction rate and weight advantages resulting from reactions driven by the systems of the present invention, the use of the instant systems in hydrogen fuel cells for powering a wide variety of mobile devices, is contemplated. Furthermore, as there is no carbon dioxide/monoxide produced in metal assisted water split reaction, this reaction is especially important for application in fuel cells, where small amount of CO contaminant in hydrogen may poison the additive and make the cell dysfunctional. Accordingly, in one embodiment of the invention, there is provided a metal-catalyst system, adapted for use in a device powered by hydrogen. In yet another embodiment, there is provided a metal-catalyst system, adapted for use in a hydrogen fuel cell.

### EXAMPLES

The above general description of the novel methods is supported through the examples of experimental results. The experiments were carried out to measure the volume of hydrogen gas produced in a reaction of aluminium powder processed with water-soluble inorganic salts (WIS). The amount of hydrogen (cc) released after 1 hr of reaction was measured by water displacement and normalized to 1 g of Al reactant. To determine variations in reaction rates additional measurements in shorter time intervals were also undertaken.

The experimental results of H₂ generation obtained from Al-WIS-water systems were compared to H₂ generation using a standard Al—Al₂O₃ powder mixture exposed to water, as described in U.S. Pat. Nos. 6,440,385 and 6,582,676 as a reference. The standard Al—Al₂O₃ powder mixture had the following composition: aluminum: 99% Al, common grade, Alcoa, 40 μm average particle size; Alumina: Al₂O₃, A16 SG, Alcoa, 0.4 μm average particle size; Al:Al₂O₃ ratio=50:50 wt %. This standard mixture was Spex milled for 15 minutes, using mill equipment and settings identical to those utilized for the test Al-WIS composites. Typical H₂ release curve from the “standard” mixture is included in all the figures below, for comparison of the features of the current invention with the previous art [U.S. Pat. Nos. 6,440,385 and 6,582,676]. Unless specified otherwise, all powders (both reference and Al-WIS) were Spex-milled for 15 min, followed immediately by packaging in paper filter bag and immersing in tap water at approximately pH=6 and T=55° C.

The following examples are provided to clearly illustrate some specific embodiments of the invention, but should not be construed as restricting the spirit or scope of the invention in any way.

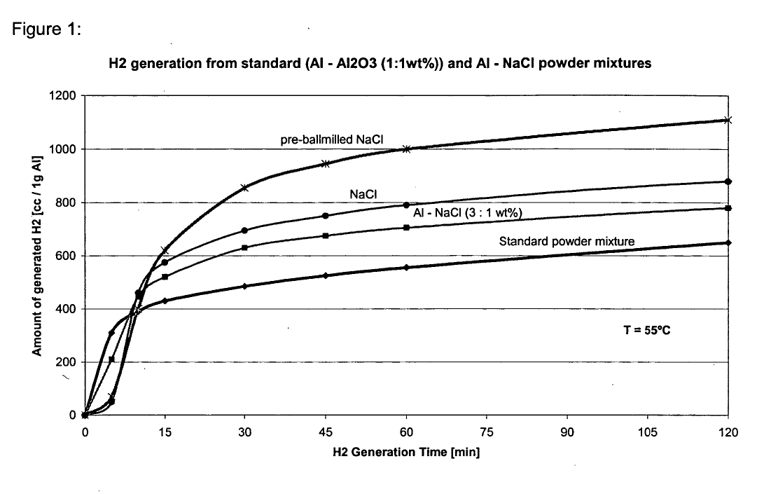

Water-Split Reaction for Al+NaCl Systems (FIG. 1)

### Example 1

Al—NaCl System

Al powder (99% Al, common grade, 40 μm average particle size, 1.5 g) and sodium chloride (common table salt, 400 μm average particle size, 1.5 g) were Spex-milled for 15 minutes. Thereafter, 2 g of the resulting powder mixture was enclosed in a paper filter bag and immersed in tap water at approximately pH=6 and T=55° C. The total amount of hydrogen released after 1 hr was 790 cc/1 g of Al (accounts to 63% of the total theoretical reaction yield value according to reaction (B) or (C)). The generated hydrogen amount surpassed the amount of hydrogen generated by the standard Al—Al₂O₃ system (50:50 wt %) under same process conditions by 41%.

### Example 2

Al—NaCl System

To further reduce the initial particle size of sodium chloride, NaCl (400 μm average initial particle size) was first pre-milled in the Spex mill for 5 min. Thereafter, 1.5 g of the pre-milled sodium chloride was mixed with the standard Al powder (99% Al, common grade, 40 μm average particle size, 1.5 g) and Spex-milled together for another 15 minutes. 2 g of the resulting powder mixture was enclosed in a paper filter bag and immersed in tap water at approximately pH=6 and T=55° C. The total amount of hydrogen released after 1 hr was 1000 cc/1 g of Al (accounts to 80% of the total theoretical reaction yield value). The generated hydrogen amount surpassed the amount of hydrogen generated by the standard Al—Al₂O₃ system, under the same preparation and reaction conditions and time, by 78%.

### Example 3

Al—NaCl System

The Al—NaCl powder mixture was prepared as described in Example 2. After milling, 2 g of the resulting composite powder was washed in 100 ml, 25° C. cold tap water for 5 min to dissolve and wash out the salt out of the plastically deformed aluminium matrix. The remaining insoluble powder (i.e. predominantly Al, but also remnant NaCl not washed out, e.g. due to complete encapsulation in Al) was enclosed in a paper filter bag and immersed in tap water at approximately pH=6 and T=55° C. for hydrogen generation test. The amount of the dissolved salt was determined by water evaporation and weighting of the residue. Approximately ⅔ (0.668 g) of the salt was recovered. Consequently, the rest of the salt (0.332 g) was enclosed in the aluminium powder.

The total amount of hydrogen released from such prepared Al:NaCl powder mixture (3:1 wt %) after 1 hr was 705 cc/1 g of Al which accounts to 56% of the total theoretical reaction yield. The generated hydrogen amount was 26% higher than the amount of hydrogen generated by the standard Al—Al₂O₃ system.

The results of Experiments 1-3 are compiled in FIG. 1, including the “standard” conditions for Al—Al₂O₃ system.

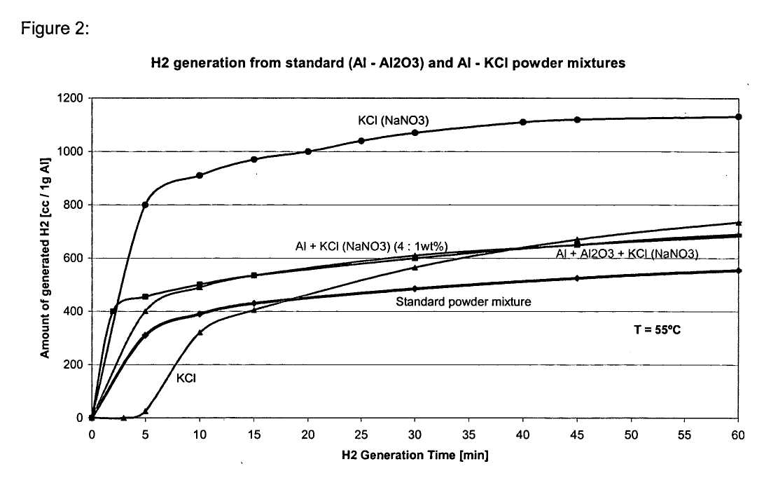

Water-Split Reaction for Al+KCl Systems (FIG. 2)

### Example 4

Al—KCl (NaNO₃) System

1.5 g of KCl (technical grade, 250 μm average particle size) was first pre-milled in the Spex mill for 5 min, with traces of NaNO₃ (<1 wt %). Thereafter, the pre-treated potassium chloride was mixed with standard Al powder (99% Al, common grade, 40 μm average particle size, 1.5 g) and Spex-milled together for another 15 minutes. 2 g of the resulting powder mixture was enclosed in a paper filter bag and immersed in tap water at approximately pH=6 and T=55° C. The total amount of hydrogen released after 1 hr was 1135 cc/1 g of Al which accounts to 91% of the total theoretical reaction yield value. The generated hydrogen amount surpassed the amount of hydrogen generated by a standard Al—Al₂O₃ system by 100%. The rate of hydrogen generation in the first 5 min of the reaction is very high and amounts to an average of 160 cc H₂/min, and the reaction starts almost immediately after submersion of the powder container in water.

### Example 5

Al—KCl (NaNO₃) System (1:0.25 wt %)

0.3 g of KCl (technical grade, 250 μm average particle size) was first pre-milled in the Spex mill for 5 min with traces of NaNO₃ (<1 wt %). Thereafter, the pre-treated potassium chloride was mixed with standard Al powder (99% Al, common grade, 40 μm average particle size, 1.2 g) and Spex-milled together for another 15 minutes. 1.25 g of the powder mixture was enclosed in a paper filter bag and immersed in tap water at approximately pH=6 and T=55° C. The total amount of hydrogen released after 1 hr was 690 cc/1 g of Al which accounts to 55% of the total theoretical reaction yield value. The generated hydrogen amount is 23% higher than the amount of hydrogen generated by a standard Al—Al₂O₃ system. The rate of hydrogen generation in the first 2 min of the reaction was very high and amounted to 200 cc H₂/min.

### Example 6

Al—Al₂O₃—KCl (NaNO₃) System

0.3 g of KCl (technical grade, 250 μm average particle size) was first pre-milled in the Spex mill for 5 min with traces of NaNO₃ (<1 wt %). Thereafter, the pre-treated potassium chloride was mixed with standard Al powder (99% Al, common grade, 40 μm average particle size, 1.2 g) as well as alumina powder (Al₂O₃ A16 SG, Alcoa, 1.2 g) and Spex-milled together for another 15 minutes. 2.25 g of the powder mixture was enclosed in a paper filter bag and immersed in tap water at approximately pH=6 and T=55° C. The total amount of hydrogen released after 1 hr was 690 cc/1 g of Al which is comparable with the amount of hydrogen produced by the Al—KCl(NaNO₃) system (1:0.25 wt %). However, the rate of hydrogen generation in the first 5 min was lower than the rate measured in the Al—KCl(NaNO₃) (1:1 wt %) system and averaged to 80 cc H₂/min. It appears that the presence of the alumina additive had no positive effect on the reaction (rather: it decreased the rate of H₂ release in the initial stages of the reaction).

### Example 7

Al—KCl System

1.5 g of KCl (technical grade, 250 μm average particle size) was first pre-milled in the Spex mill for 5 min (with no other additives present), and further processed as described in Example 4. The total amount of hydrogen released after 1 hr was 735 cc/1 g of Al which accounts to 31% of the total theoretical reaction yield value. The rate of hydrogen generation in the first 5 min of the reaction is slow.

The results of Experiments 4-7 are compiled in FIG. 2, including the “standard” conditions.

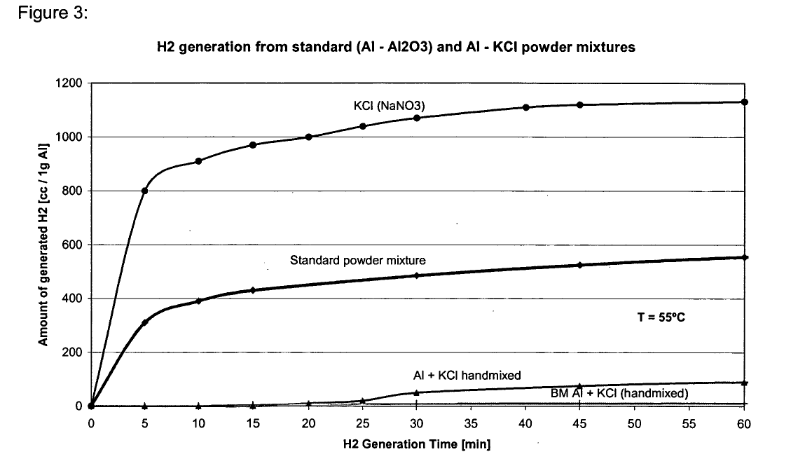

Comparison of Spex-Milled and Hand-Mixed Powders in Al—KCl System (FIG. 3)

### Example 8

1 g of standard Al powder (99% Al, common grade, 40 μm average particle size) and 1 g potassium chloride (technical grade, 250 μm average particle size) were well hand-mixed, enclosed in a paper filter bag and immersed in tap water at approximately pH=6 and T=55° C. The total amount of hydrogen released after 1 hr was 90 cc/1 g of Al. hydrogen evolution started after 20 min.

### Example 9

2 g of standard Al powder (99% Al, common grade, 40 μm average particle size) was Spex-milled for 15 minutes. After that 1 g of this pre-treated Al was well hand-mixed with 1 g of potassium chloride (technical grade, 250 μm average particle size), enclosed in a paper filter bag and immersed in tap water at approximately pH=6 and T=55° C. The total amount of hydrogen released after 1 hr was 88% lower than the amount of H₂ generated from as-received Al powder and amounted to 11 cc/1 g of Al. hydrogen evolution started slowly after 15 min.

The results of Experiments 4, 8, 9 are compiled in FIG. 3, including the “standard” conditions.

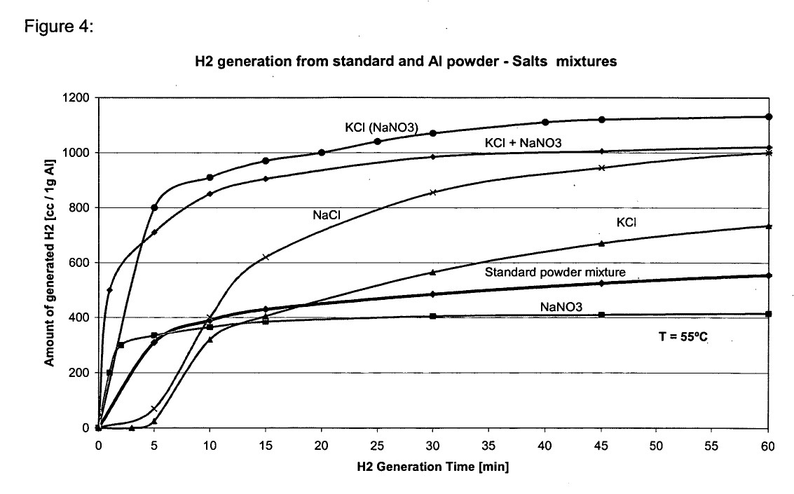

Water-Split Reaction for Al+NaNO₃ and Al+KCl+NaNO₃ Systems (FIG. 4)

### Example 10

Al—NaNO₃ System (1:1 wt %)

1.5 g of NaNO₃ (commercial grade, 1.5 mm average size particles) was first pre-milled in the Spex mill for 5 min. Thereafter, the pre-treated sodium nitrate was mixed with standard Al powder (99% Al, common grade, 40 μm average particle size, 1.5 g) and Spex-milled together for another 15 minutes. 2 g of the powder mixture was enclosed in a paper filter bag and immersed in tap water at approximately pH=6 and T=55° C. The total amount of hydrogen released after 1 hr was 415 cc/1 g of Al which accounts to 33% of the total theoretical reaction yield value. The generated hydrogen amount was 25% lower than the amount of hydrogen generated by a standard Al—Al₂O₃ system. However, the rate of hydrogen generated in the first minutes of the reaction was very high and amounted to 200 cc H₂/min in the first and 100 cc H₂/min in the second minute of the reaction.

### Example 11

Al—KCl—NaNO₃ System (1:0.91:0.09 wt %)

1 g KCl (technical grade, 250 μm average particle size) and 0.1 g of NaNO₃ (commercial grade, 1.5 mm average size spheres) were first pre-milled in the Spex mill for 5 min. Thereafter, the pre-ballmilled potassium chloride and sodium nitrate mixture was mixed with standard Al powder (99% Al, common grade, 40 μm average particle size, 1.1 g) and Spex-milled together for another 15 minutes. 2 g of the resulting powder mixture was enclosed in a paper filter bag and immersed in tap water at approximately pH=6 and T=55° C. The total amount of hydrogen released after 1 hr was 1005 cc/1 g of Al which accounts to 80% of the total theoretical reaction yield value. The generated hydrogen amount was 79% higher than the amount of hydrogen generated by a standard Al—Al₂O₃ system. The rate of hydrogen generated in the first minute of the reaction was very high and amounted to 500 cc H₂/min.

The results of Experiments are compiled in FIG. 4, including the “standard” conditions.

X-ray Analysis of the Reaction Products

### Example 12

X-ray diffraction analysis was performed on dried reaction products, primarily to determine the role of water-soluble inorganic salts in the overall reaction (e.g. possibility of formation of Al-chlorides), and the type of aluminum hydroxide formed. The fundamental question to answer was: are the WIS additives the catalysts of the aluminum-assisted water-split reaction, or are they the reactants (i.e. participate in the reaction products). All the results achieved indicate that WIS play the role of catalysts, and therefore remain as unmodified water-soluble salts after completion of the reaction. This important conclusion, in addition to water solubility of these catalysts, indicates that WIS will be easy to recover and recycle in the commercial systems for on-board H₂ generation.

X-Ray Analysis #1: Al—KCl (NaNO₃) System; All Products after Reaction Completion (FIGS. 5a and 5b)

Preparation of Reaction Products Powder for XRD Analysis:

1.5 g of KCl (technical grade, 250 μm average particle size) was first pre-milled in the Spex mill for 5 min, with traces of NaNO₃ (<1 wt %). Thereafter, the pre-treated potassium chloride was mixed with standard Al powder (99% Al, common grade, 40 μm average particle size, 1.5 g) and Spex-milled together for another 15 minutes. 2 g of the powder mixture was mixed into 50 ml tap water at approximately pH=6 and T=55° C. and occasionally stirred. The procedure was similar to the Example 4 above, but the amount of hydrogen released was not measured. After approximately 5 hr of reaction (i.e. based on previous observation we assumed that the reaction was completed) the aqueous solution with reaction products were placed in a dryer (T=65° C.) to evaporate the remaining water and dry the reaction products. Thus it is believed that all solutes and solid reaction products were recovered in the dry powder.

Findings:

The main reaction products found in the dry powder (see FIG. 5a) are potassium chloride (KCl) and aluminum mono-hydrate Al₂O₃.H₂O (Boehmite). Traces of aluminium have also been found. As indicated in a separate plot of the same XRD scan (FIG. 5b) aluminium chloride (AlCl₃) and potassium hydroxide (KOH) are not present among the reaction products.

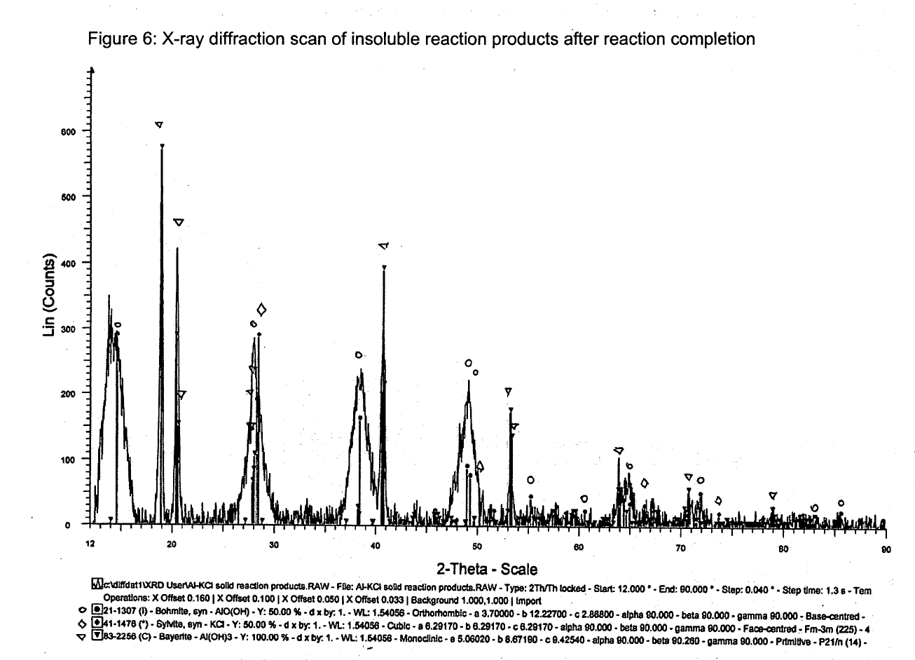

X-Ray Analysis #2: Al—KCl System: Insoluble Reaction Products after Reaction Completion (FIG. 6)

Preparation of reaction products powder for XRD analysis:

1.5 g of KCl (technical grade, 250 μm average particle size) was first pre-milled in the Spex mill for 5 min, without any other additives. Thereafter, the pre-treated potassium chloride was mixed with standard Al powder (99% Al, common grade, 40 μm average particle size, 1.5 g) and Spex-milled together for another 15 minutes. 2 g of the powder mixture was mixed into 50 ml tap water at approximately pH=6 and T=55° C. and occasionally stirred. The amount of hydrogen released was not measured. After approximately 5 hr of reaction the solid reaction products were separated from soluble reaction products that were dissolved in the water by diluting with hot water (T=55° C.-60° C.) five times. The wet solids were placed in a dryer (T=65° C.) to evaporate the remaining water and to dry the powder. The solid reaction products were weighted (2.250 g) and analyzed by XRD.

Findings:

The main reaction products were aluminum mono-hydrate Al₂O₃.H₂O (Boehmite, also represented as AlOOH) and aluminum tri-hydrate Al₂O₃.3H₂O (Bayerite, Al(OH)₃). Traces of potassium chloride (KCl) may still be present due to incomplete leaching of the salt.

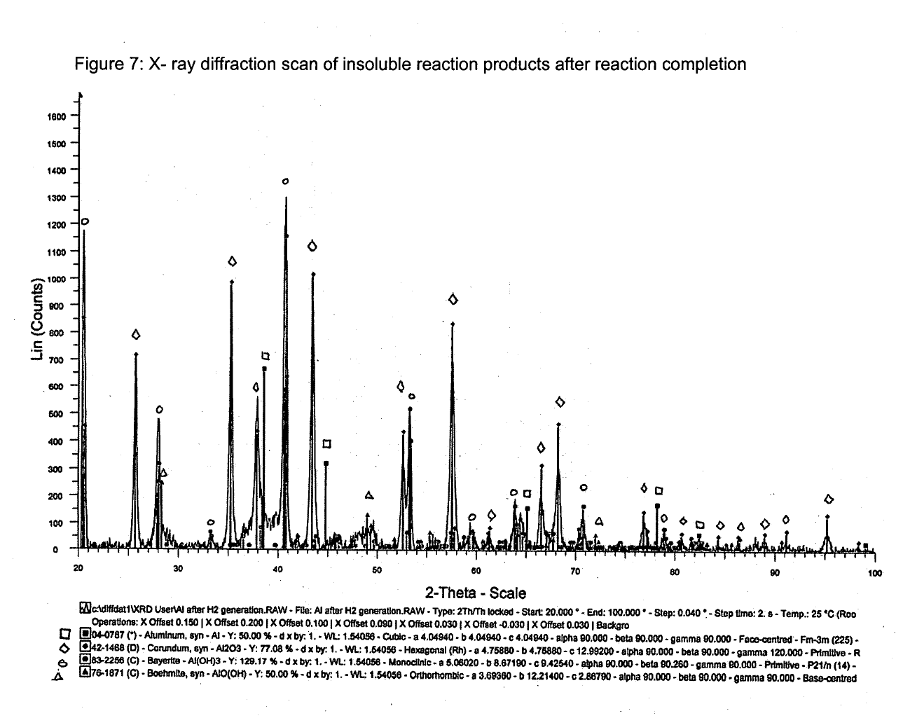

X-Ray Analysis #3: Al—Al₂O₃ “Standard” System: Insoluble Reaction Products after Reaction Completion (FIG. 7)

Preparation of Reaction Products Powder for XRD Analysis:

The standard Al—Al₂O₃ powder mixture had the following composition: aluminum: 99% Al, common grade, Alcoa, 40 μm average particle size; Alumina: Al₂O₃, A16 SG, Alcoa, 0.4 μm average particle size; Al:Al₂O₃ ratio=50:50 wt %. This standard mixture was Spex milled for 15 minutes, using mill equipment and settings identical to those utilized for the test Al-WIS composites. 2 g of the standard powder mixture was exposed to tap water at approximately pH=6 and T=55° C., for hydrogen generation. After approximately 24 hr of reaction the powder was dried and Spex reground for 15 minutes, and the hydrogen generation reaction repeated (as above) for another 24 hrs. The solid reaction products were collected and placed in a dryer (T=65° C.) to evaporate the remaining water and to dry the powder. The solid reaction products were analyzed by XRD.

Findings:

The main reaction product is aluminum tri-hydrate Al₂O₃.3H₂O (Bayerite, (Al(OH)₃); traces of boehmite AlOOH may also be present. Aluminum metal is also present due to incomplete reaction. Large amount of alpha alumina additive remains unchanged after the reaction.

In the following examples, standard aluminum powder (99.7% Al, common grade, 40 μm average particle) and water-soluble inorganic salts (WIS), mainly potassium chloride, KCl (technical grade, 250 μm average particle size) and sodium chloride, NaCl, (99.9%, Fisher Chemicals, 300 μm average particle size)—if not other specified—in Al:salt weight ratio 50:50 wt %, was used. All salts were first pre-ball-milled in the SPEX mill for 5 min, than mixed with aluminum powder and again Spex-milled for 15 min.

The powders were packed in paper filter bag and immersed in tap water at a pH between 6 and 7 and temperature T=55° C. for hydrogen generation. The produced H₂ gas was compared to the volume of H₂ gas stored at 25° C. According to the aluminum-assisted water split reaction a volume of maximum 1359 cc hydrogen gas can be produced from 1 g Al during a complete corrosion of aluminum metal in water at an ambient temperature of 25° C.

Effect of Various Salts on Aluminum-Assisted Water Split Reaction

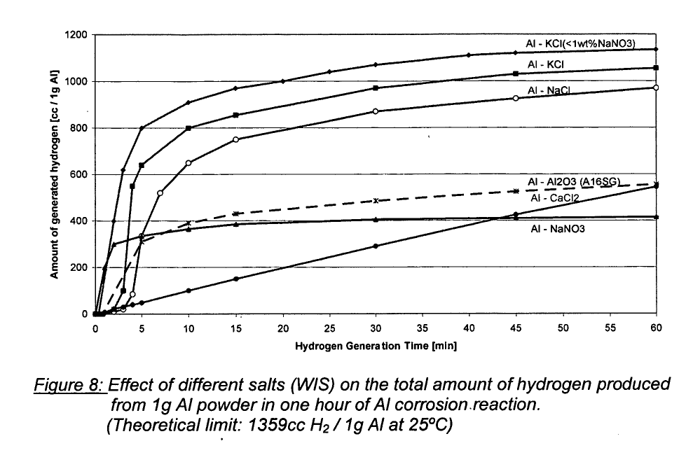

Another water-soluble salt, calcium chloride CaCl₂, was tested and compared to already presented Al-WIS systems with WIS such as KCl, KCl(NaNO₃), NaCl and NaNO₃, see FIG. 8.

### Example 15

1.1 g of CaCl₂ (anhydrous, Fisher Chemicals, 1-2 mm spheres) was mixed without pre-ballmilling due to its hygroscopic behaviour, with 1.1 g standard Al powder (99.7% Al, common grade, 40 μm average particle size) and Spex-milled together for 15 minutes. 2 g of the resulting powder mixture was enclosed in a paper filter bag and immersed in 2 L tap water at approximately pH=6.5 and T=55° C. The total amount of hydrogen released after 1 hr was 550 cc/1 g Al (accounts to 40% of the total theoretical reaction yield value). The generated H₂ amount equals the amount of hydrogen generated by a standard Al—Al₂O₃ system (50:50 wt %) under same conditions. The reaction rate in the first hour of H₂ generation seems to be linear and was averaged to 9 cc H₂/min.

Comparing all five Al-WIS systems that are presented in FIG. 8, the most reactive are Al—KCl and Al—KCl blended with traces of NaNO₃. The Al-salt powder mixtures were prepared using standard procedure: 1.1 g of the salt was pre-milled in the Spex mill for 5 min. Thereafter, the pre-treated salts were mixed with standard Al powder (99.7% Al, common grade, 40 μm average particle size, 1.1 g) and Spex-milled together for another 15 minutes. 2 g of the resulting powder mixture was enclosed in a paper filter bag and immersed in 2 L tap water at approximately pH=6.5 and T=55° C.

After one hour of reaction the Al—KCl system yielded 1055 cc H₂/1 g Al (accounts to 78% of the total theoretical reaction yield value) and the Al—KCl (<1 wt % NaNO3) system 1135 cc H₂/1 g Al (accounts to 84% of the total theoretical reaction yield value).

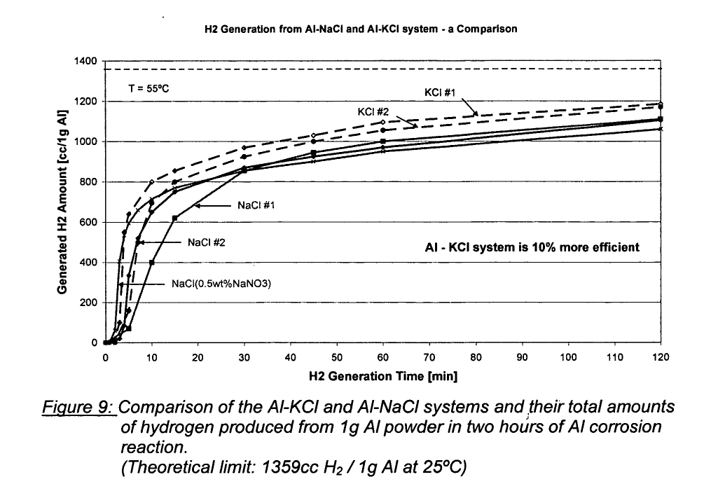

The hydrogen yields of the Al—NaCl systems are in average up to 10% lower than the H₂ yield of the Al—KCl systems. A comparison of Al—KCl and Al—NaCl is presented in FIG. 9. After one hour of reaction the Al—KCl systems yielded 1050 to 1100 cc H₂/1 g Al (accounts to 77%-81% of the total theoretical reaction yield value) whereas the Al—NaCl systems 950 to 1000 cc H₂/1 g Al (accounts to 70%-74% of the total theoretical reaction yield value). An addition of 0.5 wt % NaNO₃ to the Al—NaCl system lowers slightly the H₂ yield but increases the H₂ generation rate and decreases the induction time notably.

Effect of Additives on Aluminum-Assisted Water Split Reaction

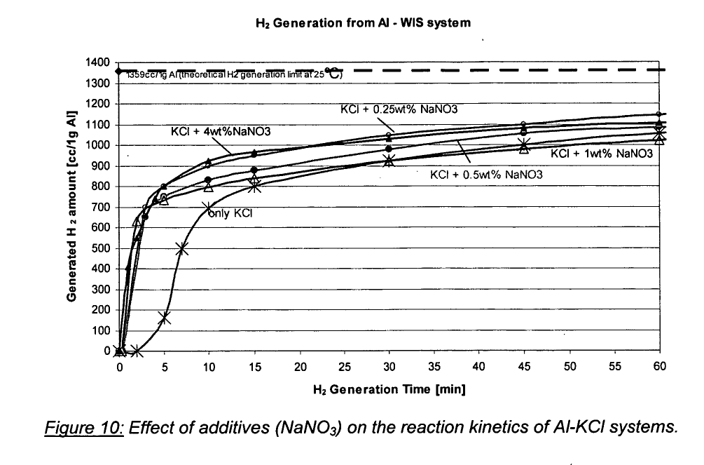

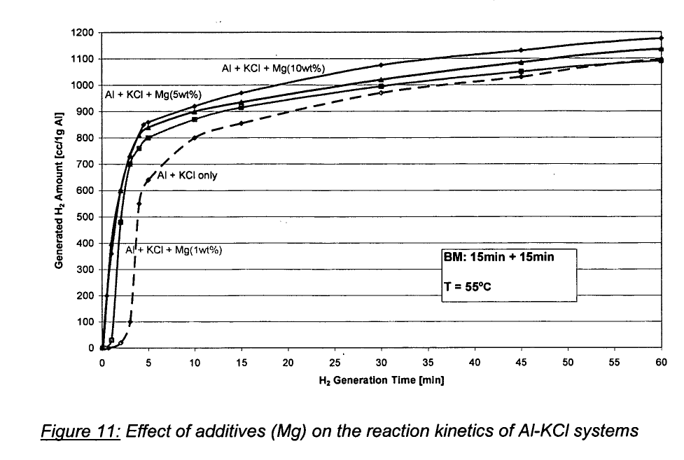

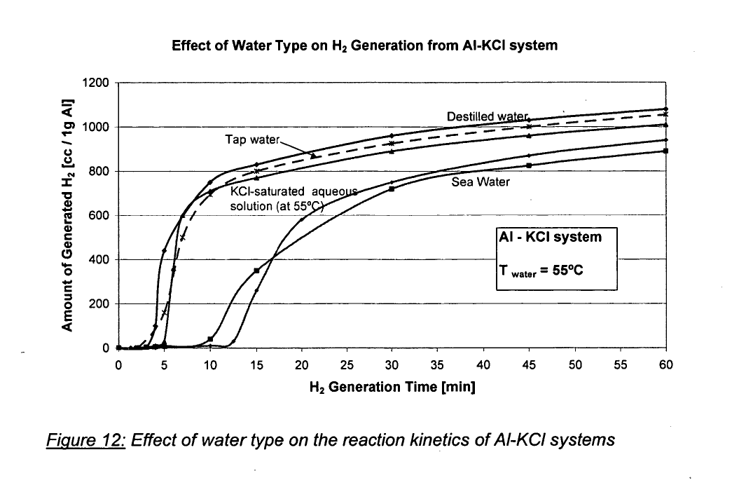

Additives, either other salts or inorganic materials, have a big influence on the corrosion kinetics of the Al-WIS-H₂O system. Depending on their amount and chemistry they can either favor or block the aluminum corrosion reaction. Two additives have been tested: (Example 16) sodium nitrate (NaNO₃) and (Example 17) magnesium metal (Mg). The results are presented in FIGS. 10 and 11. The effect of additives and/or impurities in water (Example 18) on the reaction kinetics of Al—KCl systems is shown in FIG. 12.

### Example 16

1.1 g of KCl (technical grade, 250 μm average particle size) was mixed with 0.25, 0.5, 1 and 4 wt % NaNO₃ (99.5%, Fisher Chemicals) and pre-milled in the Spex mill for 5 min. Thereafter, the pre-treated salts were mixed with standard Al powder (99.7% Al, common grade, 40 μm average particle size, 1.1 g) and Spex-milled together for another 15 minutes. 2 g of the resulting powder mixture was enclosed in a paper filter bag and immersed in 2 L tap water at approximately pH=6.5 and T=55° C. Sodium nitrate (NaNO₃), an additive with oxidizing properties, not only decreased the induction period from 2 min for the Al—KCl(only) system to immediate reaction for Al—KCl (4 wt % NaNO₃) system but it also increased the amount of generated hydrogen. The total H₂ yield however depends on the amount added. Best H₂ yields have been obtained when only traces (0.25 wt %) of NaNO₃ or amounts around 4 wt % or higher were was added to KCl, see FIG. 10. After one hour of reaction these systems yielded up to 1150 cc H2/1 g Al (accounts to up to 85% of the total theoretical reaction yield value)

### Example 17

Results with the metallic additive magnesium are presented in FIG. 11. 1.1 g of KCl (technical grade, 250 μm average particle size) was mixed with 1, 5 and 10 wt % magnesium shavings and pre-milled in the Spex mill for 15 min. Thereafter, the pre-treated Mg-salt mixture was mixed with standard Al powder (99.7% Al, common grade, 40 μm average particle size, 1.1 g) and Spex-milled together for another 15 minutes. 2 g of the resulting powder mixture was enclosed in a paper filter bag and immersed in 2 L tap water at approximately pH=6.5 and T=55° C. Magnesium metal, as seen in FIG. 11, reduced the induction time for the Al—KCl system from 1.5 min to 45 sec when 1 wt % of the Al was replaced by Mg. Immediate reaction was observed when 5 wt % or more Mg were added. hydrogen yield is less dependent on magnesium concentration in the powder even though it sporadically reacts with water forming H₂ gas and Mg(OH)₂. For the Al—KCl—Mg system the H₂ amount is approximately 10% higher after 15 minutes of reaction when comparing with the Al—KCl(only) system; however, the difference in hydrogen generation amount decreases as the corrosion reaction continues.

Al—Mg(>5 wt %)-KCl and Al—KCl(0.25 wt % NaNO₃)systems produce a comparable amount of hydrogen gas (around 1150 cc H₂) after 1 hr of H₂ generation reaction.

### Example 18

The effect of water type on the reaction kinetics of Al—KCl systems shows FIG. 12. Tested was tap, distilled, and marine (Spanish Banks, Vancouver) water as well as KCl-saturated aqueous solution (Tₛₐₜᵤᵣₐₜᵢₒₙ=55° C.). 1.1 g of KCl (technical grade, 250 μm average particle size) without any additives was pre-milled in the Spex mill for 5 min. Thereafter, the pre-treated KCl was mixed with standard Al powder (99.7% Al, common grade, 40 μm average particle size, 1.1 g) and Spex-milled together for another 15 minutes. 2 g of the resulting powder mixture was enclosed in a paper filter bag and immersed in 2 L of the to be tested water or solution at T=55° C.

The effect of the impurities commonly found in tap water (e.g. salts of alkaline and alkaline earth elements) or fresh water (e.g. organic impurities), distilled water or even highly concentrated chloride solutions (KCl-saturated aqueous solutions) on hydrogen generation or corrosion of Al is minimal. However, reduced H₂ yields and reaction rates as well as extended induction times were measured for marine waters. It seems that some of the impurities present in marine water (other the chlorides) block the corrosion reaction so that a slowed down kinetics is observed.

Effect of the Salt Concentration in the Powder Mixture on Aluminum-Assisted Water Split Reaction

### Example 19

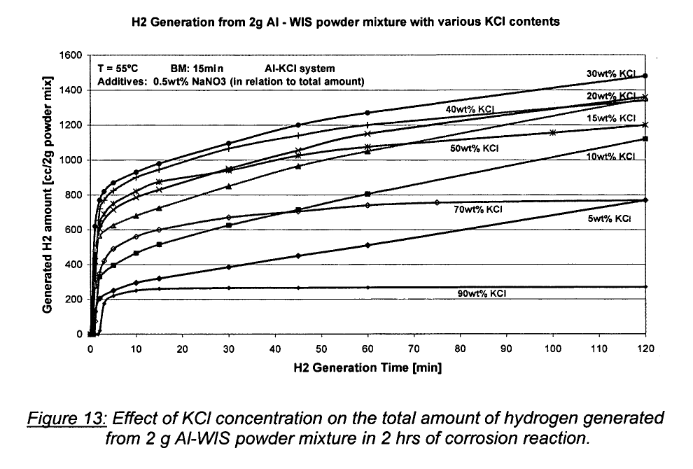

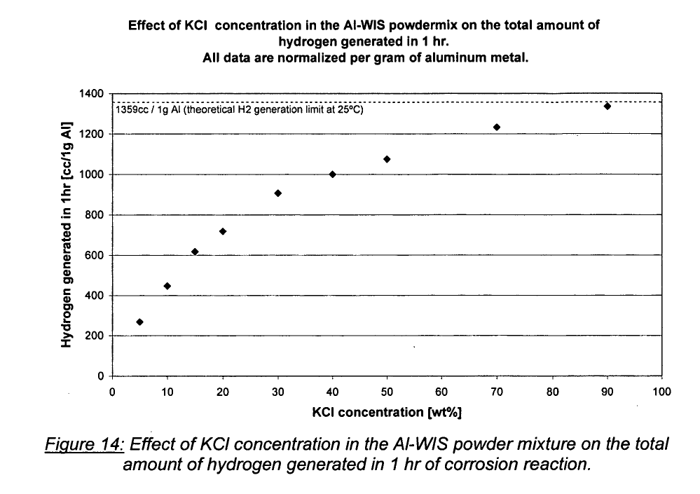

For these tests Al powder (99.7% Al, common grade, 40 μm average particle size) was used along with potassium chloride, KCl (technical grade, 250 μm average particle size) that was Spex-premilled for 5 min together with a constant amount of 10 mg NaNO₃ (0.5 wt % relative to total powder amount). All Al:KCl(NaNO₃) mixtures (from 95:5 to 10:90) were Spex-milled for 15 min. 2 g of the resulting powder mixture was enclosed in a paper filter bag and immersed in 2 L tap water at approximately pH=6.5 and T=55° C. The results are shown in FIGS. 13 and 14.

FIG. 13 presents H₂ yields that can be obtained from powders with various compositions but constant powder mass (2 g). Powder mixtures with high content of KCl (>50 %) yield hydrogen amounts below average due to decreased amount of Al in the sample (total theoretical reaction yield value decreases). Powders with very high Al content (>90%) produce also lower H₂ yields due to aluminums' cold welding and sticking to grinding media (balls and vial walls). The highest yields produce powder mixture with KCl concentrations from 20% to 40% primarily due to the increased amount of Al in the sample. The total theoretical reaction yield value is expected to increase for these powders from 1359 cc H₂ for 50:50 powder mixtures to 1900 cc H₂ for 30:70(Al) powder mixtures.

In FIG. 14 all generated H₂ amount data are normalized per gram of aluminum metal. As the KCl concentration increases in the powder mixture more hydrogen gas is generated.

Effect of Tap Water Temperature on the Al-WIS-H₂O Reaction

To determine the influence of water temperature on the Al—H₂O reaction rate and H₂ yield experiments were performed at different water temperatures in the range from 22° C. to 70° C.

### Example 20

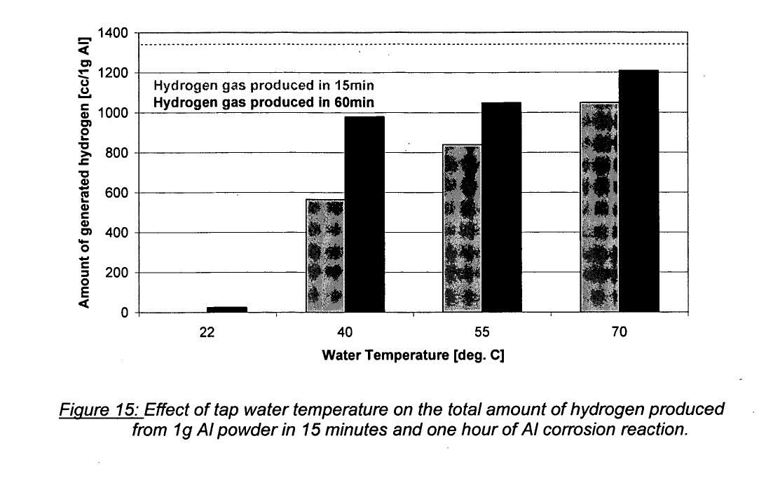

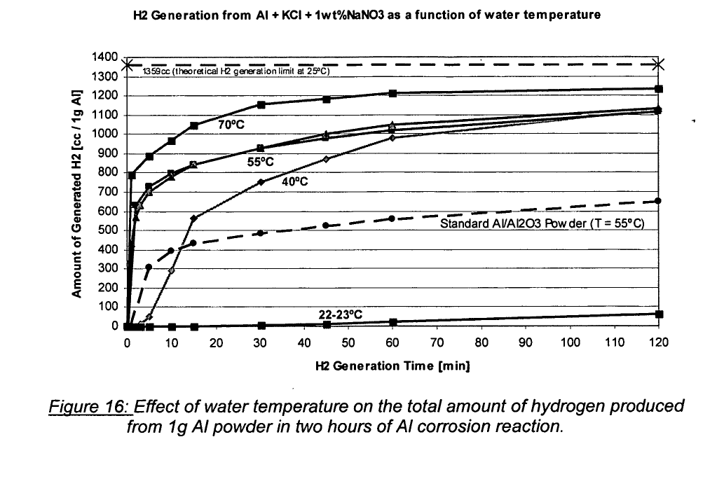

1.1 g of KCl (technical grade, 250 μm average particle size) was mixed with NaNO₃ (<1 wt %) and pre-milled in the Spex mill for 5 min. Thereafter, the pre-treated salts were mixed with standard Al powder (99.7% Al, common grade, 40 μm average particle size, 1.1 g) and Spex-milled together for another 15 minutes. 2 g of the resulting powder mixture was enclosed in a paper filter bag and immersed in 2 L tap water of 22° C., 40° C., and 55° C. at approximately pH=6.5. The total amount of hydrogen released as function of time is presented in FIGS. 15 and 16. It can be concluded that H₂ yield and H₂ generation rate of mechanically alloyed Al-salt powder mixtures tend to increase with the increase of water temperature whereas the induction time tends to decrease with the increase of water temperature. In cold water the H₂ generation reaction progresses very slowly. The first H₂ bubbles appeared after 30-40 min and after one hour less than 2% of the total H₂ yield (25 cc H₂) were obtained. In contrast, the Al—H₂O reaction in water of 70° C. is instantaneous (the reaction starts immediately after submersion of the powder in water) and fast.

The rate of hydrogen generation in the first 5 min of the reaction is very high and amounts to an average of 180 cc H₂/min. The reaction proceeds thereafter with a moderate rate; after one hour 1210 cc hydrogen gas /1 g of Al was generated which accounts to 89% of the total theoretical reaction yield value. At higher water temperatures most of the hydrogen is generated in the first minutes of the reaction. As seen in FIG. 15, 87% of the hydrogen is generated in the first 15 min when the water is hot (T_{water}=70° C.) and only 57% of the hydrogen is generated when the water is luke warm (T_{water}=40° C.). However, after 2 hrs of H₂ generation the H₂ yield of the reaction at 40° C. is comparable to the H₂ yield of the reaction at 55° C. and accounts to 83% of the total theoretical reaction yield value (1130 cc H2), even though the H2 generation rate was slower at the beginning of the reaction.

The hydrogen generation amount of the Al—Al₂O₃ system at 55° C. has been added to FIG. 16 as reference.

pH and Temperature Change During Aluminum-Assisted Water Split Reaction

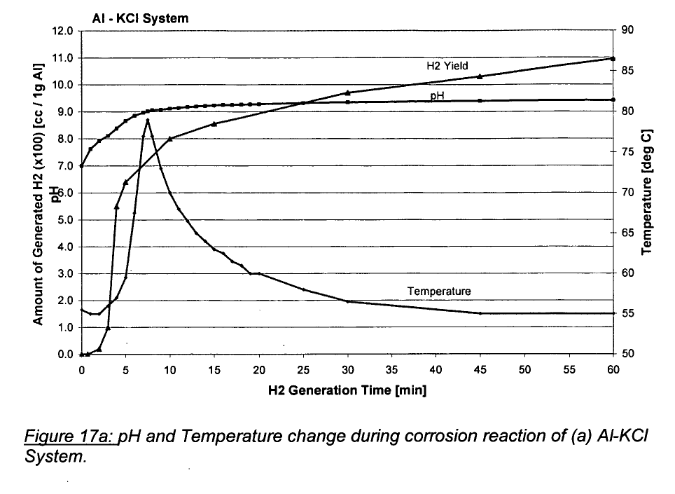

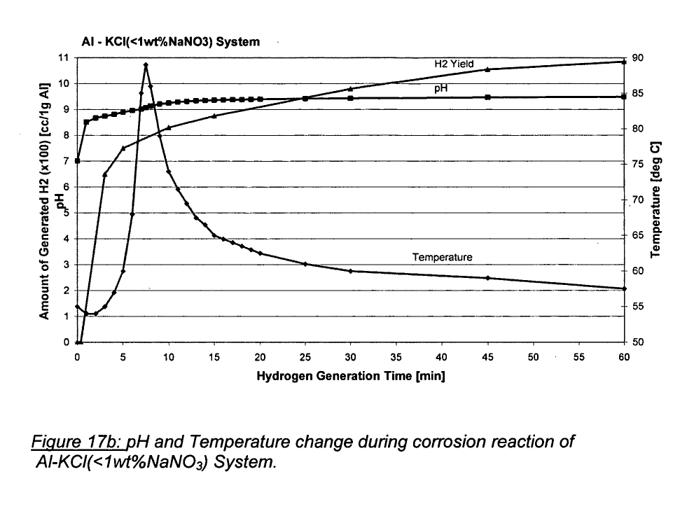

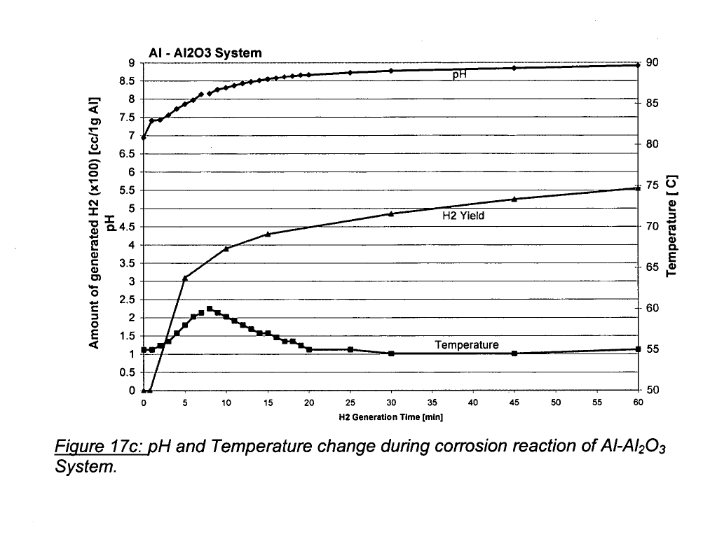

Temperature changes—since the Al—H₂O reaction is exothermic—and pH changes during the aluminum-assisted water split reaction were measured on several systems. Three of them, Al—KCl, Al—KCl(<1 wt % NaNO₃) and Al—Al₂O₃ selected as reference, are presented in FIG. 17(a-c).

### Example 21

Powder mixtures were prepared in a standard procedure as described above. Water temperatures of 55° C. and powder mixtures of 2 g weight were used for each experiment. Since temperature changes and/or pH changes are barely measurable when small amounts of powder and excessive volume of water is used, the amount of tap water has been reduced to 30 ml. pH and T have been measured simultaneously and the results plotted in FIG. 17. H₂ gas has not been collected during these tests (open system).

The H2 yields as function of H₂ generation time were implemented into the graph from previous experiments. For Al-WIS systems the bulk temperature drops initially during the induction period approx. 0.5-1° C. in the first 2 minutes due to salt dissolution and rises thereafter steep up to 79° C. for the Al—KCl system and 89° C. for the Al—KCl(<1 wt % NaNO₃). This rise is due to the massive corrosion reaction which is characterized by very high hydrogen generation rate. After that the bulk T of the Al-salt system decreases exponentially even though the reaction rates are moderate and normalizes when the H₂ production slows down (after 10-20 min) till it almost reaches the initial condition after 1 hour.

The bulk water pH shifts progressively towards higher pH values (into alkaline region) right after immersion of the powder mixture into water from pH 7 to pH 9 in the first few minutes and stabilizes thereafter at pH9.4 for both Al-WIS systems.

For the Al—Al₂O₃ system the T increases only moderately (less than 10° C.) due to moderate reaction rates and lower H₂ yields. The pH however differs only slightly from the pH of the Al-salt systems; it rises steadily and riches after 1 hour of corrosion reaction pH=9.

Effect of Ball-Milling Time on Aluminum-Assisted Water Split Reaction

### Example 22

Milling of all Al-WIS powders was performed with high energy, high impact Spex mill. The milling time for the Al—KCl(<1 wt % NaNO₃) powder mixtures, which were prepared in a standard way, was varied from 7.5 min to 4 hours. 2 g of the resulting powder mixture was enclosed in a paper filter bag and immersed in 2 L tap water at approximately pH=6.5 and T=55° C.

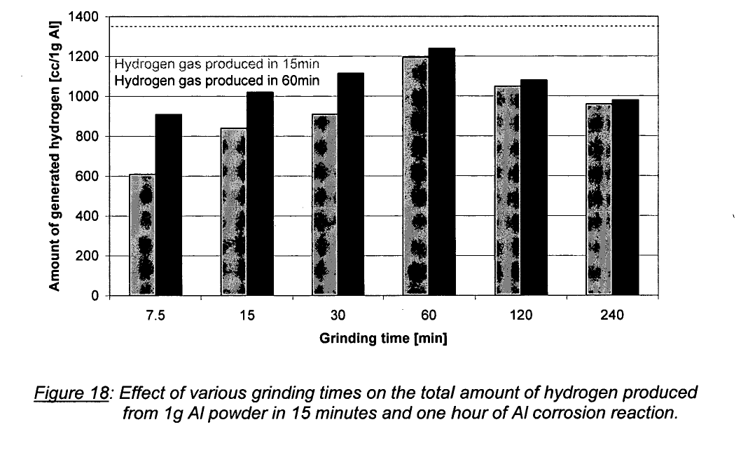

FIG. 18 reflects the effect of grinding time on corrosion or on the amount of hydrogen produced from 1 g Al powder in the Al-WIS system after 15 min and 60 min of reaction. Al corrosion increases with the increase of ballmilling duration. The total H₂ yield increased from 900 (when milled for 7.5 min) to 1240 cc H₂ (when milled for 1 hour) after 60 min of reaction time, increasing the H2 generation efficiency from 67% to 92%. Al-WIS powders that have been mechanically alloyed for more than 60 min are characterized by very high reaction rates in the first minutes of the reaction. Al in these powder mixtures corrodes almost completely (95% of the available Al) in 5 to 10 min of reaction. But these powders are also characterized by gradually decreasing H2 yields.

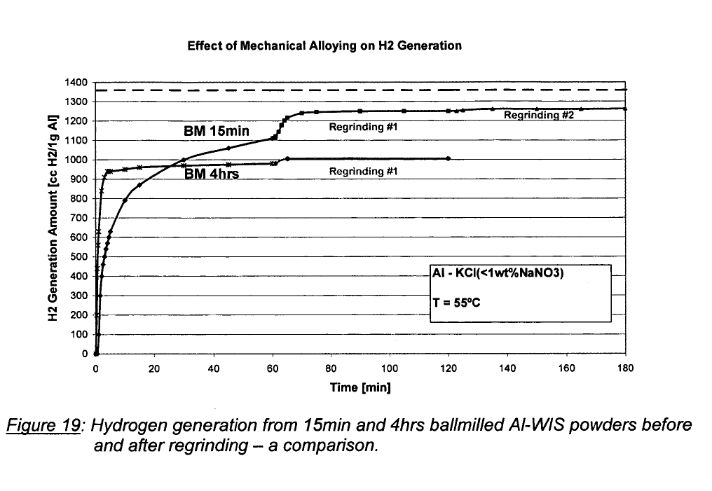

Prolonged milling in air oxidizes part of the Al powder. The longer therefore the milling process the higher percentage of Al will be scarified and lower H₂ yields will be obtained. Failed regrinding experiments which were performed to reactivate the rest Al in the sample, see FIG. 19, as well as increased oxygen concentrations in the ball-milled powders (EDS analysis) indicate Al oxidation.

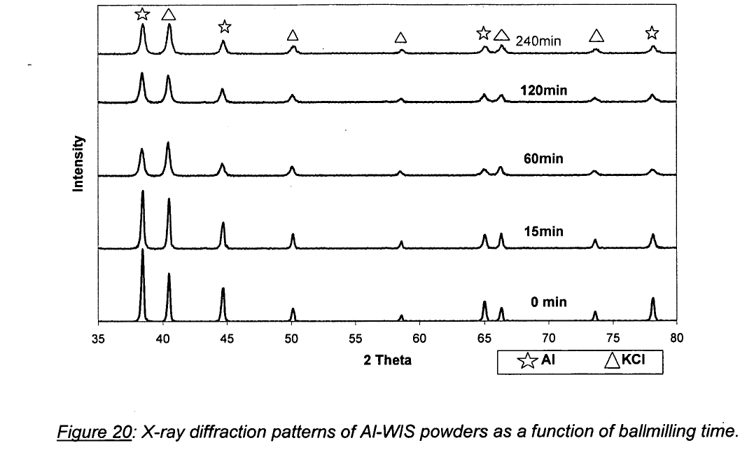

X-ray diffraction analysis that was carried out on ungrounded and up to 4 hrs ball-milled Al—KCl(<1 wt % NaNO₃) powder mixtures, see X-ray diffraction patterns in FIG. 20, gives additional information. Besides Al and KCl no new phases or solid solutions were formed during the prolonged milling process. However, peak broadening and the decrease of relative intensity of the diffraction peaks characteristic for the Al phase with increasing of grinding duration are attributed to crystallite size reduction and microstructural changes (increased lattice deformation, induction of defects, dislocations as well as microstrains).

Microscopic (SEM) investigations on mechanically alloyed Al-salts powders indicate that extended milling leads to particle refinement and therefore surface area enlargement as well as to a better and more homogenous distribution of the second phase in the Al matrix (EDS mapping).

Reaction Product Characterization

Bayerite, Al(OH)₃, and boehmite, AlOOH, are the reaction products of the aluminum-assisted water-split reactions:
Al+3H₂O→1.5H₂+Al(OH)₃ (1)
Al+2H₂O→1.5H₂+AlOOH (2)

### Example 23

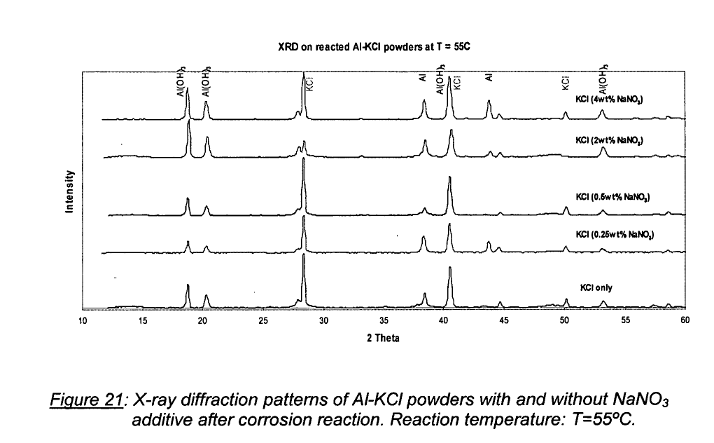

Mechanically alloyed Al—KCl(n wt % NaNO₃) powders, 2 g, which were prepared in standard way and contained n=0 wt % to n=10 wt % NaNO3 as additive reacted for 1 hr with water generating H₂ gas. After that the powder was dried and analyzed. X-ray diffraction patterns of powders which reacted in 3 different temperatures ranges were combined and are presented in FIGS. 21-23.

It has been found that Al-WIS powders which reacted in 2 L of water at temperatures close or below 55° C., FIG. 21, form predominantly bayerite, Al(OH)₃. Only small amounts of boehmite, AlOOH, are co-present.

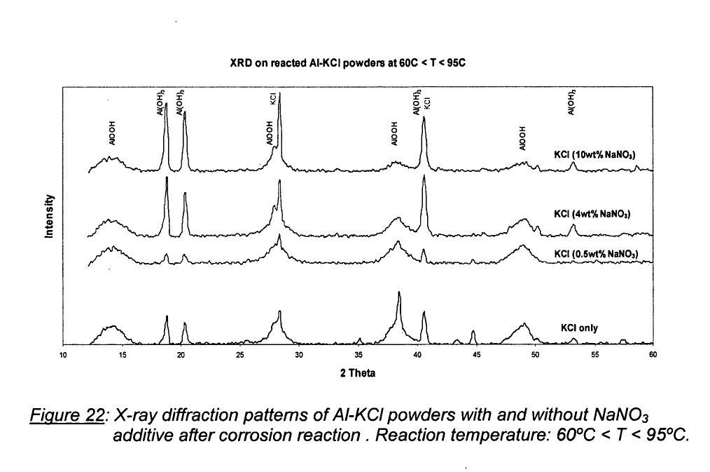

Al-WIS powders which reacted in 30 ml of water at temperatures that varied between 60° C. and 95° C. due to reaction heat, see FIG. 22, form bayerite, Al(OH)₃ and boehmite, AlOOH. Both phases are co-present in the reaction products.

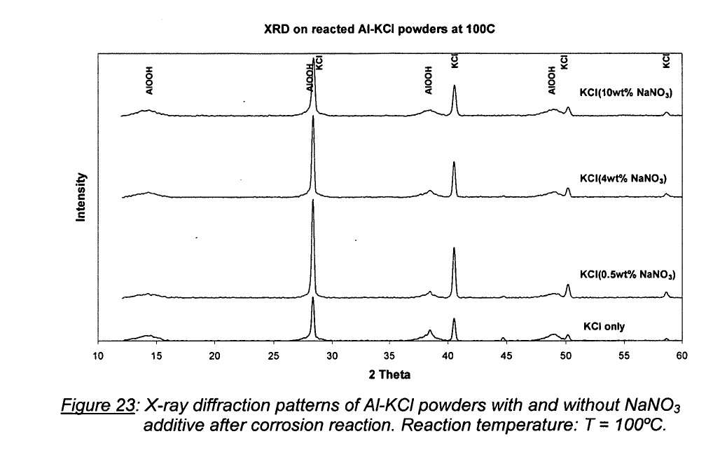

Al-WIS powders which reacted in 30 ml to 50 ml of boiling water (T=100° C.), see FIG. 23, form predominantly boehmite, AlOOH. Bayerite, Al(OH)₃, was not present in the reaction products (or has not been detected by this analysis method).

The discovery of boehmite formation at elevated reaction temperature has important technological impact—33% less water is necessary to produce the same amount of hydrogen (compare the above reactions 1, 2). As much as water may be considered as low-cost component of this system, there is an energy density penalty for carrying the water as part of the on-board fuel.

The additive NaNO₃ seems not to have any impact on the formation of neither bayerite, Al(OH)₃ nor boehmite, AlOOH.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A composition for producing hydrogen upon reaction of said composition with water, said composition comprising:
a) metal particles selected from the group consisting of aluminum (Al), magnesium (Mg), silicon (Si) and zinc (Zn); and
b) an effective amount of a catalyst.

2. The composition according to claim 1, wherein said metal particles and said catalyst are in intimate physical contact.

3. The composition according to claim 2, wherein said intimate physical contact is achieved by milling said metal particles and said catalyst.

4. The composition according to claim 3, wherein said milling is preceded by pre-milling said catalyst.

5. The composition according to claim 4, wherein said milling results in plastic deformation or mechanical alloying of said metal particles.

6. The composition according to claim 1, wherein said water soluble inorganic salt is selected from the group consisting of NaCl, CaCl₂, KCl, NH₄Cl and NaNO₃.

7. The composition according to claim 1, further comprising an additive.

8. The composition according to claim 7, wherein said additive is Mg.

9. The composition according to claim 7, wherein said additive is NaNO₃.

10. The composition according to claim 9, wherein NaNO₃ is present in trace amounts.

11. The composition according to claim 1, wherein said metal particles and said catalyst are present in a ratio of between about 1000:1 and about 1:1000 by weight.

12. The composition according to claim 1, wherein said metal particles and said catalyst are present in a ratio of between about 1:1 by weight.

13. The composition according to claim 1, wherein said catalyst is in the form of catalyst particles, and wherein said metal particles and said catalyst particles are particles in the size range between 0.01 μm and 10000 μm.

14. The composition according to claim 13, wherein said metal particles and said catalyst particles are particles in the size range between 0.01 μm and 100 μm.

15. The composition according to claim 1, wherein the catalyst has a solubility in excess of about 5×10⁻³ mol/100 g of water.

16. The composition according to claim 15, wherein the catalyst has a solubility in excess of about 0.1 mol/100 g of water.

17. The composition according to claim 1, wherein said metal particles are aluminum (Al).

18. A method for preparing a metal-catalyst composition, comprising the steps of:
a) providing metal particles that are sufficiently electropositive that the bare surface of said particles will react with water to effect a water split reaction;
b) selecting a catalyst suitable to catalyze the water split reaction; and
c) blending the particles and the catalyst into intimate physical contact with one another.

19. A method for producing hydrogen comprising reacting metal particles selected from the group consisting of aluminum (Al), magnesium (Mg), silicon (Si) and zinc (Zn) with water in the presence of an effective amount of catalyst at a pH of between 4 and 10 to produce reaction products which include hydrogen, the catalyst comprising at least one water-soluble inorganic salt to facilitate the reacting of said metal particles with the water.

20. The method according to claim 19, wherein said metal particles and said catalyst are in intimate physical contact.

21. The method according claim 20, wherein said intimate physical contact is achieved by milling said metal particles and said catalyst.

22. The method according to claim 21, wherein said milling is preceded by pre-milling said catalyst.

23. The method according to claim 22, wherein said milling results in plastic deformation or mechanical alloying of said metal particles.

24. The method according to claim 19, wherein said water soluble inorganic salt is selected from the group consisting of NaCl, CaCl₂, KCl, NH₄Cl and NaNO₃.

25. The method according to claim 19, further comprising an additive.

26. The method according to claim 25, wherein said additive is Mg.

27. The method according to claim 25, wherein said additive is NaNO₃.

28. The method according to claim 27, wherein NaNO₃ is present in trace amounts.

29. The method according to claim 19, wherein said metal particles and said catalyst are present in a ratio of between about 1000:1 and about 1:1000 by weight.

30. The method according to claim 19, wherein said metal particles and said catalyst are present in a ratio of between about 1:1 by weight.

31. The method according to claim 19, wherein said catalyst is in the form of catalyst particles, and wherein said metal particles and said catalyst particles are particles in the size range between 0.01 μm and 10000 μm.

32. The method according to claim 31, wherein said metal particles and said catalyst particles are particles in the size range between 0.01 μm and 100 μm.

33. The method according to claim 19, wherein the catalyst has a solubility in excess of about 5×10⁻³ mol/100 g of water.

34. The method according to claim 33, wherein the catalyst has a solubility in excess of about 0.1 mol/100 g of water.

35. The method according to claim 19, wherein said metal particles are aluminum (Al).

36. The method according to claim 19, wherein said reacting is at a pH of between 4 and 9.

37. The method according to claim 19, wherein the temperature of said water is between 22-100° C.

38. The method according to claim 19, wherein the water is selected from the group consisting of fresh, tap, distilled and marine water.

39. A method for producing hydrogen comprising reacting the composition according to claim 1 with water at a pH of between 4 and 10 to produce reaction products which include hydrogen, the catalyst comprising at least one water-soluble inorganic salt to facilitate the reacting of said metal particles with the water.

40. A metal-catalyst system for generating hydrogen from a water split reaction, said system comprising:
a) a composition according to claim 1;
b) water; and
c) means for containing the system.

41. The metal-catalyst system according to claim 40, wherein said system has been adapted for a device requiring a hydrogen source.

42. The metal-catalyst system according to claim 41, wherein said device is a hydrogen fuel cell.
